(19) United States
(12) Patent Application Publication
(10) Pub. No.: US 2012/0248777 A1
(43) Pub. Date: Oct. 4, 2012

(54) DEVICE FOR POWER GENERATION WITH LARGE FLOW RATE BY SMALL WATER-LEVEL DIFFERENCE

(76) Inventor: Masahiro Ikemura, Kanagawa (JP)

(21) Appl. No.: 13/202,912

(22) PCT Filed: Feb. 22, 2010
(86) PCT No.: PCT/JP2010/001124

§ 371 Date: Jun. 18, 2012

(30) Foreign Application Priority Data
Feb. 23, 2009 (JP) 2009-065173

(51) Int. Cl. F03B 13/08

(52) U.S. Cl. 290/54

(57) ABSTRACT

As for the floodgate which it flows into one-way from a tide level, the High Water Source flowing in is made, and the Low Water Source flowing out is made. A tank is located between these Water Sources, repetition of the feed water from a high-water level, and the drain to a low-water level, it generates electricity by rotating a air turbine by the pressure in a Tank. As for the method of the improvement in efficiency, a turbine is set to Air Duct between two sets of tanks, the double electric power is obtained by interlocking with opposite feed water and drain. Moreover, the variation of electric power is improved by shifting the cycle of the tank of parallel movement. And it responds to water level in a tank, the stable production of electricity is obtained by the drive of selection of the turbine of the capacity difference of a parallel drive. If this mechanism is opened and closed with the underwater valve of a big flow, it becomes possible to obtain the big electric power. The underwater valve of the Specific-gravity near water is made into locking mechanism, locking is canceled at the case of opening, the valve closed by own weight when a stream stops, thereby, a big flow is made to control with energy conservation. Moreover, there is attachment of efficiency improvement mechanism and the increase difference mechanism of Water Sources in this invention.

### BACKGROUND OF THE INVENTION

1. Field of the Invention

This invention is an example of evolution of the Japanese patent 2005-154588, the High Water Source is made from the high tide inflow, the Low Water Source is made from the outflow to ebb tide, this is the hydroelectric power generation using that water level difference, moreover, hydroelectric power generation can be performed also in the river which can be made the water source with the water level difference.

2. Description of Related Art

As for the conventional low water level difference, the water-wheel cannot handle the large flow because the fluid friction is large, a practical power plant was not able to be made by efficiency and cost. As for the power generation by the air-turbine attached to the Tank, the power plant of big electric power becomes possible by the Big Flow Underwater Valve driven with little energy.
Patent Document 1: Japanese Patent Application No.H08-227317
Patent Document 2: Japanese Patent Application No.2005-154588
Patent Document 3: Japanese Utility Model Registration Application No.S59-181032
Patent Document 4: Japanese Patent Application No.H11-174445
Patent Document 5: Japanese Utility Model Registration Application No.S60-161316
Patent Document 6: Japanese Patent Application No.2004-287402
Patent Document 6: Japanese Patent Application No.S56-60882

Because environment which can make the water source of the low water level difference exists very mostly in the river, the energy which can be utilized is expandable if power generation of the big flow of the low water level difference is realizable by low cost. The energy source of tide level change is expandable on a large scale because the tide level change exists inexhaustibly if it is the seashore, this actualizes the Large Flow Hydroelectric Power Generation with the low water level difference, low cost, and efficient.

### BRIEF SUMMARY OF THE INVENTION

Terminological definition is clarified below.

“Tank” signifies the tank of all the kind. “Water” signifies the liquid. “Valve” signifies the valve of all the kind. “Feed-and-Drain Valve” signifies both the Feed Water Valve and the Drain Valve. “Water Source” signifies both the High Water Source and the Low Water Source. “Air Duct” signifies all the ducts of the air. And “Air Valve” signifies the valve set to this duct. “Tank Space” signifies the part of the air in the Tank. “upside water” signifies the outside of the water. “Underwater Valve” signifies all the valves which open and close the underwater aqueduct of this Pressure Occurrence Mechanism. And “Floodgate” includes the valve. As for “Locking Valve”, it closes that locating the Locking Protrusion to the locus which blocks opening of an Underwater Valve, in the case of the Underwater Valve opening, the Locking Projection is transferred to the position which does not obstruct opening of the Underwater Valve, it opens the Plug-Part of the water level difference pressure, and it is the Underwater Valve of the feature to open and close it by the little energy. “Locking Protrusion” is a part of the Locking Valve, and it is the part which moves to the position which blocks opening of the Locking Valve. As for “Feed-Water Valve-Control”, an applicable Tank closes the Drain Valve, and opens the Feed Water Valve, supplies water, and this Tank is made full of water. As for “Drain Valve-Control”, an applicable Tank closes the Feed Water Valve, and opens the Drain Valve, drains away, and this Tank is made to bottom of water.

As for the definition of “Specific-gravity” in this invention, underwater “Mass/Cubic Substance” is changed into underwater “Gravity/Cubic Substance”. As for “Specific-gravity Valve”, it is the valve which has made the Specific-gravity of the Underwater Valve close to the Specific-gravity of water, and is the valve which moves by few streams. “Water Source Valve” is the valve which makes the Water Source of the Pressure Occurrence Mechanism of the Locking Valve.

As for “Forced Closing Valve”, it is doubly attached to the Feed Water Valve or the Drain Valve of this mechanism, and it is the Underwater Valve which stops the Accident Flow. As for “Accident Flow”, if both the Feed Water Valves of the High Water Source and the Drain Valve of the Low Water Source open, it cannot close the Locking Valve by the power of the flow, and this signifies the condition of a continuation stream. “Valve Sensor” is a sensor which detects the condition of opening and closing of the valve.

“Crank” is the following, as for mutual structure of locking of the Locking Valve, the strength of the contraction directions is supported by straight line layout, and it is made to close, moreover the mode of release of locking is made open by breaking down it straight line layout.

As for “Selection Drive”, plural ducts with a turbine are equipped by the simplex Tank, these turbines are chosen and used, total energy is obtained from these moving turbines, the case which obtained energy from it turbine, it is called that it is “available”. The case which does not obtain energy, it is called that it is “null”. As for “Aggregate Torque”, the torque of plural turbines is gathered, and one torque is outputted. “Passage Duct” signifies both the Open Air Duct and the Between Tanks Air Duct. “Duct Valve” is the valve which opens and closes the Passage Duct. “Feedback Air Duct” is the Air Duct which connects the inlet and outlet of the turbine. The valve set in this Feedback Air Duct is the “Feedback Valve”. The valve which changes the flow of that Feedback Air Duct and the Passage Duct is the “Change Valve”. “Rotation Connection” is structure which torque is transmitted. The shaft, the gear, the belt, the chain, etc. which are many method are included.

“Air-Intake-and-Exhaust Proper-Quantity Program” is the following, as for the Selection Drive, it change the total capacity of the turbine according to level difference change by the level in each Tanks to the High Water Source, it is program of smoothing of this torque.

“High-pressure Generation Mechanism” is the following, as for the mechanism which made series connection of the Open Air Ducts of plural Pair 3rd Tanks, that Open Air Ducts of the both end of series connection are set as input and output, and each. Underwater Valves are controlled by High-pressure Occurrence Process, it is the mechanism which makes the Open Air Ducts occurrence high pressure of the summed series connection. “High-pressure Occurrence Process” is an operating procedure of the High-pressure Generation Mechanism, each Underwater Valves of the High-pressure Generation Mechanism are controlled. That process becomes below, as for the polarity of the Pair 3rd Tank, the Tanks setting by one full of water and another bottom of water, the summed Pressure Occurrence Mechanism becomes possible by continuation series connection of Pair 3rd Tanks, it signifies process of this high-pressure occurrence. “Outflow Pump Process” and “Inflow Pump Process” are the followings, as for the High-pressure Generation Mechanism, the Open Air Ducts of the outflow tank or the inflow tank is connected to the end of one side of this Open Air Duct, Underwater Valves and Air Valves are controlled, and pump movement is made with the summed pressure, the above signifies this Process.

“Drain Hollow” is the following, the waterway of the river lower stream is connected in the same water level of the Low Water Source, it is the hollow of the lower locus than the bottom of the river lower stream, the Drain Valves of the Tanks are set in underwater of the hollow.

“Unnecessary Procurement Water Level Difference” is the following, as for the water level of the Water Source by the side of the open-valve which confronts the water level in the Tank, or the mutual water level difference connected underwater in the Pair 3rd Tank. The acquisition energy decreases if the water level difference decreases, this signifies the water level difference of it unnecessary procurement. “Feed-and-Drain Time Program” is the following, it is based on the time of open-beginning of the Feed-and-Drain Valve of the Tank, it is program which performs the operation of the Underwater Valve and the Air Valve by presumed time, even if there are not the Valve Sensor and the water level sensor, electronic control of this Pressure Occurrence Mechanism can be made possible.

“Pressure Load” is connected with the Open Air Duct of the 1st Tank-the 3rd Tank, it is mechanism which works with pressure, and as for it, the turbine, the piston, etc. applicable.

“Phase Difference Smooth Program” is the following, as for the 1st Tank to the 3rd Tank which are plural number, it is program which shifts cycle of feed-and-drain of each Tank, is made to open and close the Underwater Valve, and makes parallel operation, it is characterized by lessening instability of the amount of emergence of energy.

“Airtight Opening” is the following, the Tank water level rises by the Feed-Water Valve-Control, and the Tank water level fall by the Drain Valve-Control, these influence the airtight of that Tank Space. Hence, the condition of Air-pass of the inside and outside of the Tank is influenced. However, in the case of the Between Tanks Air Duct, because it is mutual Air-pass, “Release of Airtight Opening” is also airtight.

According to an aspect of the present invention, a little water level difference large flow power generator, comprising: there is a Tank placed between a Low Water Source and a High Water Source, there is a Feed Water Valve for opened and closed between that Tank and its High Water Source, there is a Drain Valve for opened and closed between that Tank and its Low Water Source, its Tank is equipped with an Open Air Duct of the input-and-output of pressure, this passes Tank space to the exterior, this is Push-pressure occurs in its Open Air Duct by Feed-Water Valve-Control, this is Pull-pressure occurs in its Open Air Duct by Drain Valve-Control, above is the characteristic of this Pressure Occurrence Mechanism, the above is the 1st comprise of the 1st Tank, as for the 2nd comprising, there are the two aforesaid 1st Tanks, the both Tank Space of 1st Tank has passed by the Between Tanks Air Duct, this Between Tanks Air Duct can equip a turbine, the above is a Pair 2nd Tank, as for this Pair 2nd Tank, it is possible to make that turbine drive by the Feed-Water Valve-Control of one 2nd Tank and the Drain Valve-Control of another 2nd Tank, as for 3rd comprising, there are the two aforesaid 1st Tanks, the both underwater of 1st Tank has passed by the Underwater Passage, this Underwater Passage is equipped with an Underwater Passage Valve, the above is a Pair 3rd Tank, all the Feed-and-Drain Valves of its Pair 3rd Tank are closed, as for the situation of one bottom-of-water 3rd Tank and another Full-of-water 3rd Tank, if that Underwater Passage Valve opening is made, the Open Air Duct of the former 3rd Tank become push-pressure, the Open Air Duct of the latter 3rd Tank become pull-pressure, as for an aforesaid the 1st Tank-the 3rd Tank, the Electrical Control Unit which controls opening and closing of an aforesaid an Underwater Valve is equipped, that Electrical Control Unit makes pressure by opening and closing of that Underwater Valve, the above is the Pressure Occurrence Mechanism.

These Locking Valves of the 1st Tank-the 3rd Tank equips the Specific-gravity Valves, it is the characteristic which can be opened and closed with little energy, this is the Locking Specific-gravity Valve Mechanism.

The Underwater Valves of the 1st Tank-the 3rd Tank equips the Specific-gravity Valve, as for the 1st Specific-gravity Valve, that Underwater Valve is driven from upside water, that movable Structure is equipped with the weight of balance structure of a pulley or seesaw, the underwater weight of that Underwater Valve and that upside water weight are balanced nearly, hence, the underwater Specific-gravity of the Underwater Valve resembles the Specific-gravity of water, as for the 2nd Specific-gravity valve, this Underwater Valve equips emptiness structure made to resemble to the Specific-gravity of water, as for the structure of the aforesaid 1st Specific-gravity Valve and the aforesaid 2nd Specific-gravity Valve, this reduces the drive bottleneck of opening and closing by own weight, and it is movable with few streams, above is the Specific-gravity Valve Mechanism.

As for the mechanism of the Specific-gravity Valve of the 1st Tank-the 3rd Tank, the Underwater Valve is driven from upside water, the power equipment which makes it drive is equipped, this opens and closes that Specific-gravity Valve with little energy, the above is a Specific-gravity Valve Drive.

As for the simplex tank of above 1st Tank-3rd Tank, the Forced Closing Valve which overlapped with both or one side of the aforesaid Feed-and-Drain Valves are equipped, if Accident Flow occurs, that Forced Closing Valve is closed by electronic control, the above is the feature of this Pressure Occurrence Mechanism.

As for the structure which obstructs opening of a Locking Valve of the 1st Tank-the 3rd Tank, the open locus of its Locking Valve is equipped with the Locking Protrusion of the locking structure of the crank, that Locking Valve obstructs and locks opening in the line of the Crank of the Locking Protrusion, that Locking Valve is opened with the form which breaks down the Crank of the Locking Protrusion which can be Locking-release, it is the Crank Locking Mechanism of the characteristic which locks and Locking-release the Locking Valve as mentioned above.

The little water level difference large flow power generator according to the Locking Valve, the equipment which the Locking Protrusion locks on Upside Water is equipped, the electronic device which controls locking by Upside Water is equipped, the above is valve locking mechanism.

The little water level difference large flow power generator according to the Underwater Passage, as for the 1st exhaust equipment of the Underwater Passage of the Pair 3rd Tank, as for the Underwater Passage between the water surface of a High Water Source, and the water surface of a Low Water Source, an Underwater Passage Exhaust Passage with a Underwater Passage Exhaust Valve is equipped, about Feed-Water Valve-Control of the 3rd Tank which the Underwater Passage Exhaust Passage has passed, the air of the Underwater Passage is exhausted by opening of the Underwater Passage Exhaust Valve, as for the 2nd exhaust equipment, about the Underwater Passage above the water surface of the Low Water Source, the Underwater Passage Exhaust Passage with the Underwater Passage Exhaust Pump is equipped, the air of Underwater Passage is exhausted with the Underwater Passage Exhaust Pump, as for the 1st exhaust equipment and 2nd exhaust equipment, this is the exhaust equipment which exhausts the air of the Underwater Passage.

The little water level difference large flow power generator according to the 1st Tank-the 3rd Tank, the 1st Tank-the 3rd Tank are equipped with the water level sensor which measures the water level to the High Water Source, the Low Water Source, and the 1st Tank-the 3rd Tank, based on the data of each water level sensor, each Underwater Valve is opened and closed with the Electrical Control Unit, the above is the Pressure Occurrence Mechanism of the characteristic.

The little water level difference large flow power generator according to 1st Tank-3rd Tank, as for the 1st Pressure Occurrence Mechanism of the 1st Tank-the 3rd Tank, the 1st Tank and the 3rd Tank are equipped with the parallel Open Air Ducts with the turbine, as for the 2nd Pressure Occurrence Mechanism, the Pair 2nd Tank is equipped with the parallel Between Tanks Air Ducts with the turbine, as for the above 1st Pressure Occurrence Mechanism and the above 2nd Pressure Occurrence Mechanism, energy is synthetically obtained from those by the Selection Drive of each turbine, thus, the Selection Drive of each turbine is made from the Displacement Optimization Program of electronic control, the Selection Driving of Pressure Occurrence Mechanism characterized by the above.

As for the 1st Torque Aggregate Mechanism of Pressure Occurrence Mechanism of Selection Drive, extension of each turbine at the Pressure Occurrence Mechanism of Selection Drive is equipped with the clutch, the Passage Ducts of those turbines are equipped with the Duct Valves, aggregate Torque of those clutches is Output, the Selection Drive is available by interlocking with opening of the Duct Valves and Rotation Connection of the clutches, the Selection Drive is null by interlocking with closing of the Duct Valves and release of the clutches, as for the 2nd Torque Aggregate Mechanism, Rotation Connection of the rotation axes of all the turbines of the Pressure Occurrence Mechanism of the Selection Drive is made, all those turbines are equipped with the Feedback Air Duct, its Passage Ducts of those turbines are equipped with Duct Valves, all the Feedback Air Ducts are equipped with the feedback valves, as for opening of the Duct Valve and closing of the Feedback Valve, the Selection Drive is available because torque occurs to the turbines, as for closing of the Duct Valve and opening of the Feedback Valve, the Selection Drive is null because the turbines idles, as for the 3rd Torque Aggregate Mechanism, Rotation Connection of the rotation axes of all the turbines of the Pressure Occurrence Mechanism of the Selection Drive is made, all those turbines are equipped with the Feedback Air Ducts, the Change Valves of passage of the Passage Ducts and passage of the Feedback Air Duct are equipped, as for passage of the Passage Duct and closing of the Feedback Air Duct, the torque of the turbine occurs and the Selection Drive is available, as for closing of the Passage Duct, and passage of the Feedback Air Duct, the turbine idles and Selection Drive is null, as for the 4th Energy Aggregate Mechanism, the rotation axes of all the turbines of the Pressure Occurrence Mechanism of the Selection Drive are equipped with the dynamos, moreover, the Accumulation-of-electricity Mechanism of those dynamos is equipped, the Selection Drive with electric charging of the dynamo is available, the Selection Drive with cannot electric charging of the dynamo is null, as for the 1st Torque Aggregate Mechanism-the 3rd Torque Aggregate Mechanism and the 4th Energy Aggregate Mechanism, the energy which gathered is obtained from Displacement Optimization Program of electronic control, the above is the Energy Aggregate Mechanism of the characteristic.

As for plural Pair 3rd Tanks, Series connection of the Open Air Duct of those both edges is made, as for that series connection of the Open Air Duct of one edge and the Open Air Duct of another edge, one of it or both are set as an input/output, as for the electronic control by High-pressure Occurrence Process, the Underwater Valve of each 3rd Tank is opened and closed, summation push-pressure occurs to the Open Air Duct of one edge of series connection, summation pull-pressure occurs in another Open Air Duct, the above is the High-pressure Generation Mechanism.

The Open Air Duct of one end of this High-pressure Generation Mechanism and the Open Air Duct of the 1st Tank are connected, as for the composition of an Outflow Pump, an Outflow Pipe is equipped with the Non-return Valve which flows in the extrusion direction, this Outflow Pipe is passed by the Summation High-water Level Tank higher than the water level of the High Water Source from underwater of that 1st Tank, that 1st Tank is an Outflow Tank, as for the composition of an Inflow Pump, an Inflow Pipe is equipped with the Non-return Valve which flows in the raising direction, that Inflow Pipe is passed by the Summation Low-water Level Tank lower than the water level of the Low Water Source from underwater of that 1st Tank, that 1st Tank is an Inflow Tank, as for the electronic control of the aforesaid Outflow Pump, each Underwater Valve is opened and closed with the Outflow Pump Process, as for the electronic control of the aforesaid Inflow Pump, each Underwater Valve is opened and closed with the Inflow Pump Process, it is a pump mechanism of the aforesaid characteristic.

As for the case which the Specific-gravity Valves are used for the Water Source Valve, the Water Source Valve which flows to the inflow directions is equipped between the tide level and the High Water Source, the Water Source Valve which flows to the outflow directions is equipped between the tide level and the Low Water Source, that High Water Source and its Low Water Source are made into the Water Source of the Pressure Occurrence Mechanism, the above is the Water Source Making Mechanism of the characteristic.

As for the Water Source Valve of the Water Source Making Mechanism, that Flow Path cross section makes it the structure which spreads to the directions of the sea, the vertical interval of the wave brought near by the Water Source Valve by the variation of the wave is emphasized, this increases the flow to the Water Source Valve, and the vertical interval of the Water Source is increased, the above is the Water Source Vertical Interval Increase Mechanism of the characteristic.

As for the case of river installation, the High Water Source of the Pressure Occurrence Mechanism is a River High-water Level Cistern, a sluice is equipped between the upper stream of a river and the River High-water Level Cistern, the lower stream of a river is equipped with the Low Water Source where the Drain Hollow was attached, the water of a high-water level is taken in from the river upper stream by the sluice, this is a water source of the Pressure Occurrence Mechanism.

As for the control method of the aforesaid Forced Closing Valve, the 1st Tank-the 3rd Tank are equipped with the Forced Closing Valve, a water level sensor and a stream sensor are equipped in the 1st Tank-the 3rd Tank, if a stream without water level change in the 1st Tank-the 3rd Tank occurs, a judgment is made in case of the Accident Flow, because the Forced Closing Valve is closed by electronic control, that Accident Flow is stopped, this is the control method of the Forced Closing Valve.

As for the control method of a Forced Closing Valve, all the Underwater Valves of the 1st Tank-the 3rd Tank are equipped with a Valve Sensor, as for the tank of the simplex of either the 1st Tank-the 3rd Tank, the condition that both a Feed Water Valve and a Drain Valve are open is the 1st Detection, this is the 1st Detection Forced Closing Valve, as the 2nd Detection of the Pair 3rd Tank, opening of an Underwater Passage Valve, opening of the Feed Water Valve of one 3rd Tank, and opening of the Drain Valve of another 3rd Tank, the 2nd Detection is these three, a Forced Closing Valve is double equipped to one of Feed Water Valve and Drain Valve, this is the 2nd Detection Forced Closing Valve, as for the case where the 1st Detection or the 2nd Detection occurs by the Valve Sensor, the former is closed by electronic control in the 1st Detection Forced Closing Valve, the latter is closed by electronic control in the 2nd Detection Forced Closing Valve, this is the Forced Closing Valve Control Method of stopping the Accident Flow.

As for the Discharge Method of the air of the Underwater Passage of the 1st Exhaust Equipment, about the Underwater Passage Exhaust Passage of the 1st Exhaust Equipment, the Feed-Water Valve-Control of the 3rd Tank passed to it is performed, this Underwater Passage Exhaust Valve is opened, the air of this Underwater Passage is exhausted, an Underwater Passage Exhaust Valve is closed after that close, this is the Underwater Passage Air Discharge Method.

As for the drive method of the 1st Tank-the 3rd Tank, these 1st tank-the 3rd tank are equipped with the Pressure Open Valve, about the tank water level of the 1st tanks and the 2nd Tank, the water level difference to the Water Source water level of the side which a valve opens is the 1st Water Level Difference, as for opening of the Underwater Passage Valve of the Pair 3rd Tank, the water level difference of this mutual 3rd Tank is the 2nd Water Level Difference, as for closing of the Underwater Passage Valve of the Pair 3rd Tank, about the tank water level of one of the 3rd Tank, the water level difference to the Water Source water level of the side which a valve opens is the 3rd Water Level Difference, as for the case where the 1st Water Level Difference-the 3rd Water Level Difference are the Unnecessary Procurement Water Level Difference, the Pressure Open Valve is opened by electronic control, because to perform feed-and-drain of a tank quickly, the above is the Pressure Occurrence Method of the characteristic.

As for the Drive Method of the 1st Tank-the 3rd Tank, this tank of the Passage Duct is equipped with Pressure Load, noting that it is based on the time of an open start of an Underwater Valve, the electronic control of the Feed-and-Drain Time Program opens and closes the Underwater Valves and the Air Valves, the above is the characteristic of this Pressure Occurrence Method.

The little water level difference large flow power generator according to the Drive Method of the 1st Tank-the 3rd Tank, as for the plural 1st Tanks or plural Pairs 2nd Tank, or the plural Pairs 3rd Tank, these Passage Ducts are equipped with the turbines, the energy of the torque of these plural turbines is collected, the cycle of opening and closing of the Underwater Valve of these Tanks are shifted by parallel action of the Phase Difference Smooth Program of electronic control, it is decreasing fluctuation of recoverable energy, the above is the characteristic of the energy recovery method.

As for Selection Drive Pressure Occurrence Mechanism, the 1st Tank-the 3rd Tank are equipped with plural parallel Passage Duct with a turbine, the Selection Drive of each turbine is made in the electronic control of Displacement Optimization Program, hence, the variation of the acquirement energy is decreased by switchover of the total capacity of a turbine, the above is the Energy Acquirement Method of the characteristic.

As for the drive method of the High-pressure Generation Mechanism, moreover, as for the polarity of the unit of the Pair 3rd Tanks of the order of this series connection, it is stipulated that one is the 3rd Tank A and another side is the 3rd Tank B, all the the Underwater Passage Valve of the High-pressure Generation Mechanism is closed, the Airtight Opening of all the Tanks is made, the Feed-Water Valve-Control of all the 3rd Tanks A is made, the Drain Valve-Control of all the 3rd Tanks B is made, as for the above, closing of all the Feed-and-Drain Valves and the cessation of the Airtight Opening are the completion of preparation of the High-pressure Occurrence, the Air pass of all the Passage Duct of series connection is made, and all the Underwater Passage Valves are opened, the Summed Pull-pressure occurs in the Open Air Duct of the 3rd Tank A to the edge of series connection, the Summed Push-pressure occurs in Air Duct of the 3rd Tank B of an another side edge, the above is the High-pressure Occurrence Method by the High-pressure Occurrence Process.

The little water level difference large flow power generator according to the Drive Method of the aforesaid Outflow Pump, as for the direction to the Series Connection of the Outflow Pump by the Pair 3rd Tanks of simplex, it is postulated that the Outflow Tank side of that is the 3rd Tank B, and it is postulated that the other side of this is the 3rd Tank A, as for a control process, all the Underwater Passage Valves of an Outflow Pump are closed, airtight Opening of all the Tanks are performed, Feed-Water Valve-Control of an Outflow Tank and all the 3rd Tank A are performed, Drain Valve-Control of all the 3rd Tank B is performed, all the Feed-and-Drain Valves are closed, sealing of Airtight Opening of all the Tanks are performed, the above condition is made standby of pump action, if it passes through all the Passage Duct of this series connection, furthermore, If opened by all the Underwater Passage Valves, it sends out water with an Outflow Pipe to a cistern with higher than the High Water Source, this is the Outflow Pump Control Method by an Outflow Pump Process.

The little water level difference large flow power generator according to the Drive Method of the aforesaid Inflow Pump, as for the direction to the Series Connection of the Inflow Pump by the Pair 3rd Tanks of simplex, it is postulated that the Inflow Tank side of that is the 3rd Tank B, and it is postulated that the other side of this is the 3rd Tank A, as for a control process, all the Underwater Passage Valves of an Inflow Pump are closed, Airtight Opening of all the Tanks are performed, Drain Valve-Control of an Inflow Tank and all the 3rd Tank A are performed, Feed-Water Valve-Control of all the 3rd Tank B is performed, all the Feed-and-Drain Valves are closed, sealing of Airtight Opening of all the Tanks are performed, the above condition is made standby of pump action, if it passes through all the Passage Duct of this series connection, furthermore, if opened by all the Underwater Passage Valves, it take in water with an Inflow Pipe to a cistern with lower than the Low Water Source, this is the Inflow Pump Control Method by an Inflow Pump Process.

As for the Production Mechanism of the Water Source of the Pressure Occurrence Mechanism, the Tide Level Detection Sensors and the Electronic Opening-and-closing Floodgates between the tide level and the Water Sources are equipped, as for the information on the Tide Level Detection Sensor, its floodgate of the High Water Source is opened at the time of the high-water level, its floodgate of the High Water Source is closed except the time of the high-water level, its floodgate of the Low Water Source is opened at the time of the low water level, its floodgate of the Low Water Source is closed except the time of the low water level, it is the Water Source Manufacturing Method which makes the Water Sources from the tide level by opening and closing of both the floodgates by the above electronic control.

As for the Water Source Production Method of the Pressure Occurrence Mechanism, the sluice opened and closed by an Electrical Control Unit is equipped between a tide level and a Water Source, as for the electronic control by time, the sluice of a High Water Source opens on the assumed high tide schedule, the sluice of the High Water Source closes except a high tide schedule, the sluice of a Low Water Source opens to the assumed ebb tide schedule, the sluice of a Low Water Source closes except an ebb tide schedule, it is a Water Source Manufacturing Process which makes a Water Source from a tide level by opening and closing by the aforesaid Electrical Control Unit.

### BRIEF DESCRIPTION OF THE DRAWINGS

FIG. 1 is cross-sectional views illustrating the 1st Tank is a bottom of water;

FIG. 2 is cross-sectional views illustrating the 1st Tank made the pressure occurrence by Feed-Water Valve-Control;

FIG. 3 is cross-sectional views illustrating the 1st Tank is a full-of-water condition;

FIG. 4 is cross-sectional views illustrating the 1st Tank is a pressure occurrence by Drain Valve-Control;

FIG. 5 is cross-sectional views illustrating a turbine is a rotation condition by interlocking movement of the 2nd Tank;

FIG. 6 is cross-sectional views illustrating feed-and-drain of FIG. 5 is opposite and a turbine is a reverse rotation condition;

FIG. 7 is cross-sectional views illustrating a pressure occurrence and feed-and-drain of the 3rd Tank;

FIG. 8 is cross-sectional views illustrating standby of a pressure occurrence of the 3rd Tank;

FIG. 9 is cross-sectional views illustrating the Underwater Passage of the 3rd Tank locates on upside water;

FIG. 10 is cross-sectional views illustrating the Accident Flow of the 1st Tank flows to a Low Water Source from a High Water Source;

FIG. 11 is cross-sectional views illustrating the Forced Closing Valves of the 1st Tank closed;

FIG. 12 is cross-sectional views illustrating the Accident Flow of the Pair 3rd Tank;

FIG. 13 is cross-sectional views illustrating the 1st Tank is a high-water level;

FIG. 14 is cross-sectional views illustrating the 1st Tank is a middle water level;

FIG. 15 is cross-sectional views illustrating the 1st Tank is the Unnecessary Procurement Water Level Difference;

FIG. 16 is waveform chart illustrating pressure of the 1st tank water level;

FIG. 17 is waveform chart illustrating time and pressure in the 1st Tank Pressure Load;

FIG. 18 are schematic diagram illustrating parallel movement of three sets of the 1st Tanks;

FIG. 19 is waveform chart illustrating time and pressure of each Tank in FIG. 18;

FIG. 20 is waveform chart illustrating the time versus total work of FIG. 18;

FIG. 21 is cross-sectional views illustrating the Small Capacity Turbine of the 1st Tank;

FIG. 22 is cross-sectional views illustrating the Large Capacity Turbine of the 1st Tank;

FIG. 23 is cross-sectional views illustrating all the turbines of the 1st Tank drive;

FIG. 24 is waveform chart illustrating time and work of each turbine capacity;

FIG. 25 is waveform chart illustrating time and total work of the Selection Drive;

FIG. 26 is schematic diagram illustrating an electrical control unit with the 1st Tank;

FIG. 27 is schematic diagram illustrating an electrical control unit with the 2nd Tank;

FIG. 28 is schematic diagram illustrating an electrical control unit with the 3rd Tank;

FIG. 29 is schematic diagram illustrating a electronic control of the 1st Tank Forcible Closing Valve;

FIG. 30 is schematic diagram illustrating the Selection Drive electronic control of the Duct Valves;

FIG. 31 is schematic diagram illustrating the Selection Drive of the Change Valves;

FIG. 32 is schematic diagram illustrating the Selection Drive of the Duct Valves and the Feedback Valves;

FIG. 33 is schematic diagram illustrating the Selection Drive of the electric clutches and the Duct Valves;

FIG. 34 is block flow diagram illustrating the example of control of a Tank;

FIG. 35 is block diagram illustrating the basic form of the electronic control of the 1st Tank;

FIG. 36 is block diagram illustrating the basic form of the electronic control of the 2nd Tanks;

FIG. 37 is block diagram illustrating the basic form of the electronic control of the 3rd Tanks;

FIG. 38 is block diagram illustrating the basic form of the electronic control of the Selection Drive of three sets of the 1st Tanks;

FIG. 39 is cross-sectional views illustrating opening of the Specific-gravity Valve of a small water level difference;

FIG. 40 is cross-sectional views illustrating closing of Specific-gravity Valve of an equal water level;

FIG. 41 is cross-sectional views illustrating a water level inflow of the High Water Source of a high tide;

FIG. 42 is cross-sectional views illustrating a water level outflow of the Low Water Source of a ebb tide;

FIG. 43 is cross-sectional views illustrating a water level storage of the High Water Source of a ebb tide;

FIG. 44 is cross-sectional views illustrating a water level storage of the Low Water Source of a high tide;

FIG. 45 is cross-sectional views illustrating the High Water Source utilizing of the 1st Tank;

FIG. 46 is cross-sectional views illustrating the Low Water Source utilizing of the 1st Tank;

FIG. 47 is cross-sectional views illustrating the Specific-gravity Valve is locked at a rotation piston;

FIG. 48 is cross-sectional views illustrating locking and release of FIG. 47 are driven on upside water;

FIG. 49 is configuration illustrating locking of the Specific-gravity Valve is a Crank structure;

FIG. 50 is cross-sectional views illustrating the locking of the Specific-gravity Valve closes with a Crank;

FIG. 51 is cross-sectional views illustrating the locking of the Specific-gravity Valve is opening of a Crank;

FIG. 52 is cross-sectional views illustrating the locking of the Specific-gravity Valve is upside water drive;

FIG. 53 is cross-sectional views illustrating the upside water drive of the Specific-gravity Valve, and Crank of a rotary cylinder;

FIG. 54 is cross-sectional views illustrating the locking of Crank of the upside water drive of the Specific-gravity Valve;

FIG. 55 is cross-sectional views illustrating the locking of the Specific-gravity Valve is an upside water pressure drive;

FIG. 56 is cross-sectional views illustrating the both-directions locking of the Underwater Passage Valve;

FIG. 57 is cross-sectional views illustrating the Specific-gravity-Regulating of the upside water weight of the Underwater Valve;

FIG. 58 is cross-sectional views illustrating the Specific-gravity-Regulating of the upside water weight of the wire of the Underwater Valve;

FIG. 59 is cross-sectional views illustrating the Specific-gravity-Regulating of the upside water weight of the Underwater Valve in a Tank;

FIG. 60 is cross-sectional views illustrating the Specific-gravity-Regulating of the outside-tank weight of the underwater Valve in a tank;

FIG. 61 is cross-sectional views illustrating the upside water pressure drive of a Specific-gravity-Regulating Underwater Valve;

FIG. 62 is cross-sectional views illustrating the upside water pressure drive of the wire of an Specific-gravity-Regulating Underwater Valve;

FIG. 63 is cross-sectional views illustrating the upside water gear drive of a Specific-gravity-Regulating Underwater Valve;

FIG. 64 is cross-sectional views illustrating the upside water wire rolling-up drive of a Specific-gravity-Regulating Underwater Valve;

FIG. 65 is cross-sectional views illustrating the upside water motor drive of a gear drive Specific-gravity Valve;

FIG. 66 are schematic diagram illustrating a Water Source Making Mechanism of electronic control;

FIG. 67 are cross-sectional views illustrating a Outflow Pump;

FIG. 68 are cross-sectional views illustrating a Inflow Pump;

FIG. 69 is cross-sectional views illustrating make of the Summation high-water Level Tank by the tide level;

FIG. 70 is cross-sectional views illustrating make of the Summation Low-water Level Tank by the tide level;

FIG. 71 is configuration illustrating a Difference Amplification Mechanism of the wave of a High Water Source;

FIG. 72 is configuration illustrating a Difference Amplification Mechanism of the wave of a Low Water Source;

FIG. 73 is configuration illustrating the Water Source using the slope of the river;

FIG. 74 is schematic diagram illustrating the alternating current transformation circuit of the conventional electric power;

FIG. 75 are cross-sectional views illustrating first action pressure of the conventional turbine;

FIG. 76 are cross-sectional views illustrating the turbine of a new brainchild suitable for this invention;

### DETAILED DESCRIPTION OF PREFERRED EMBODIMENTS

This invention is the mechanism of a supplement of “Japanese Patent Application No.2005-154588”.

As for the Tank of FIGS. 1-4, 7-9, the external Pressure Load of the Pressure Occurrence Mechanism (U1) can be utilized for the power of the drive by the occurrence pressure of the Open Air Duct (D1). As for the Tank of FIGS. 1-9, the torque can be intermittently obtained by repetition of feed water and drain if the bidirectional movable turbine is used for the Passage Duct, the 1st Tanks (T1) of FIGS. 1-4 are a basic form of the principle of this invention. The Water Sources in figures are very large compared with the Tanks if actual, the delineation which valve in the figures cannot be seen by the Flow Path shows the open condition of the valves. The same Water Source of the drawing separated all over the figure is connected.

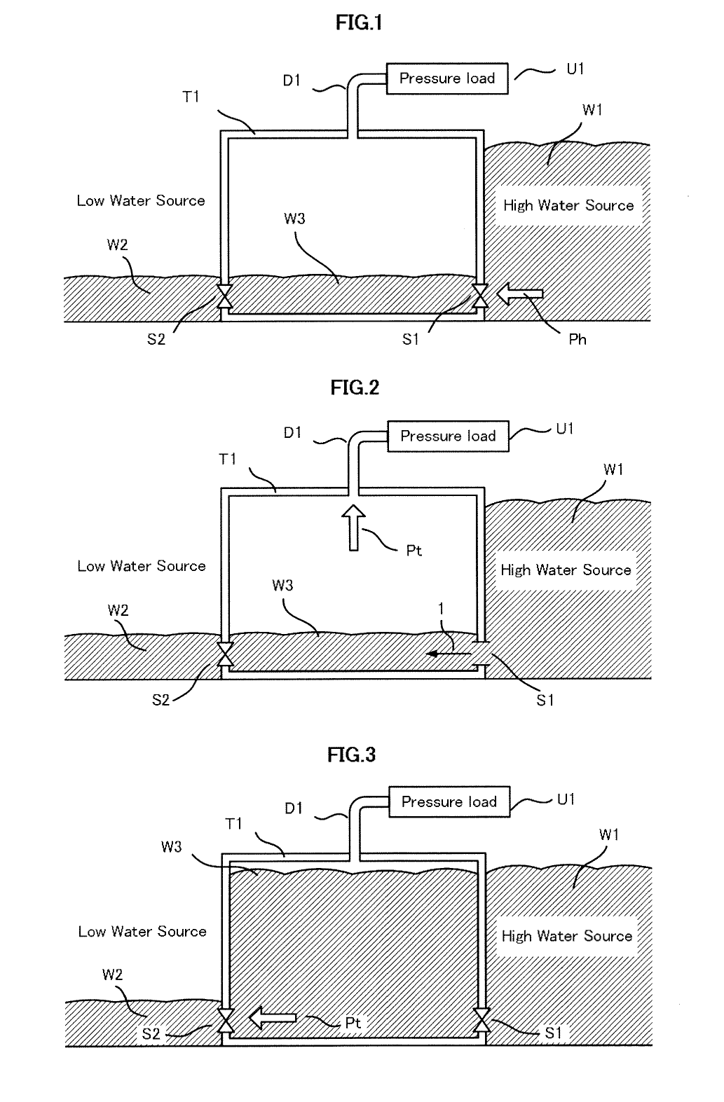

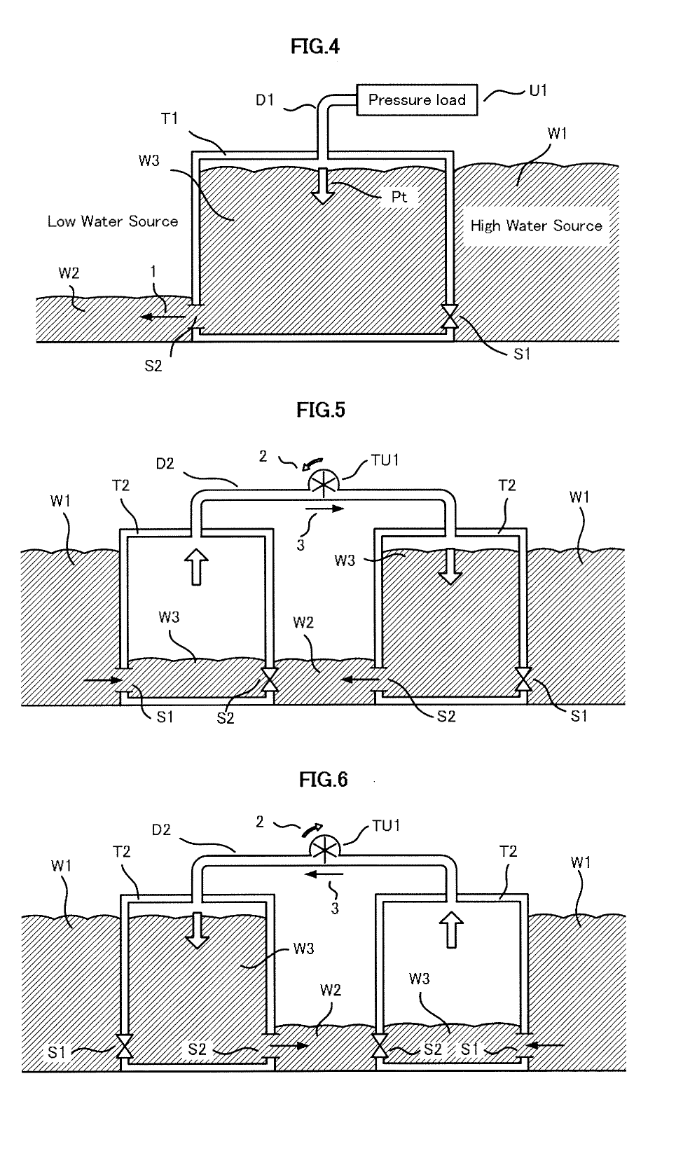

As for FIGS. 1-4, the 1st Tank (T1) is located between the High Water Source (W1) and the Low Water Source (W2). As for FIG. 2, it becomes supplying water by closing of the Drain Valve (S2), and opening of the Feed Water Valve (S1), and the Push-pressure in the Open Air Duct (D1) occurs, and it works on the Pressure Load (U1). This movement of this Feed-and-Drain Valve is the Feed-Water Valve-Control. As for FIG. 4, it becomes drained by closing of the Feed Water Valve (S1) and opening of the Drain Valve (S2), the Pull-pressure occurs in the Open Air Duct (D1) and it works on the Pressure Load (U1). This movement of this Feed-and-Drain Valve is the Drain Valve-Control.

As for in FIG. 5 and FIG. 6 of the Pair 2nd Tank (T2), if interlocking movement with opposite the Feed-Water Valve-Control and the Drain Valve-Control is performed, as for the occurrence pressure of the Between Tanks Air Duct (D2), as compared with the one unit of 1st Tank (T1), it can drive the turbine (TU1) with the pressure of double. Next, the Feed-Water Valve-Control and the Drain Valve-Control of the mutual 2nd Tanks (T2) are changed, then, the turbine (TU1) can be driven by repeating the reversal of the pressure of push and pull. Therefore, this mechanism obtains torque intermittently.

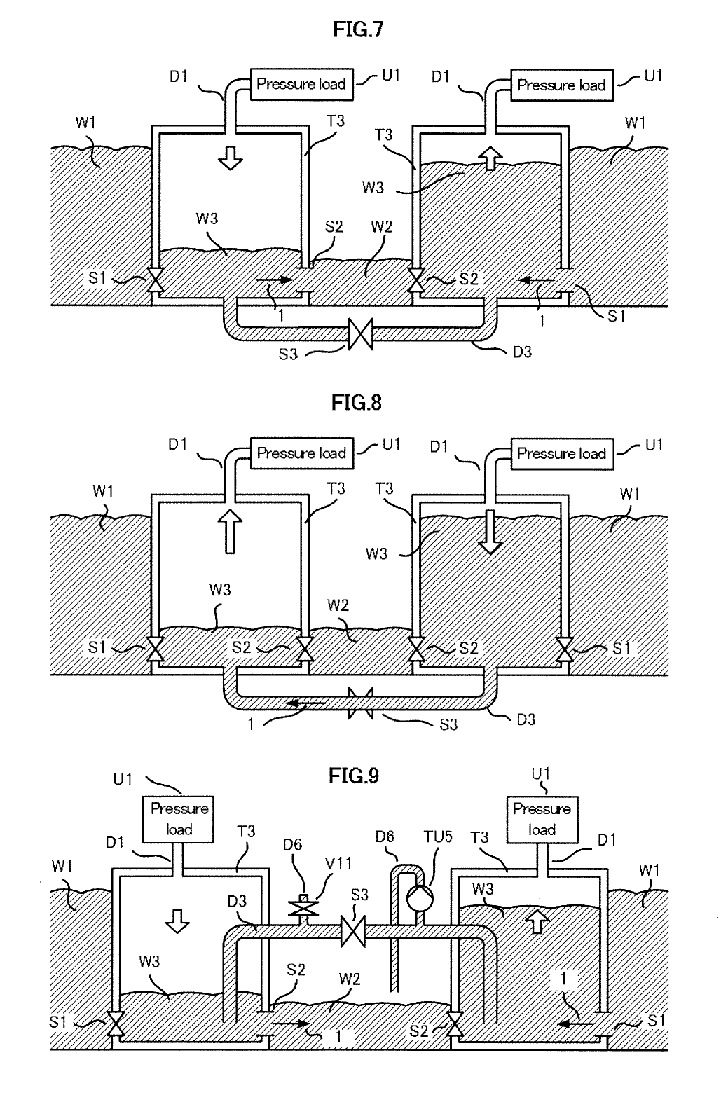

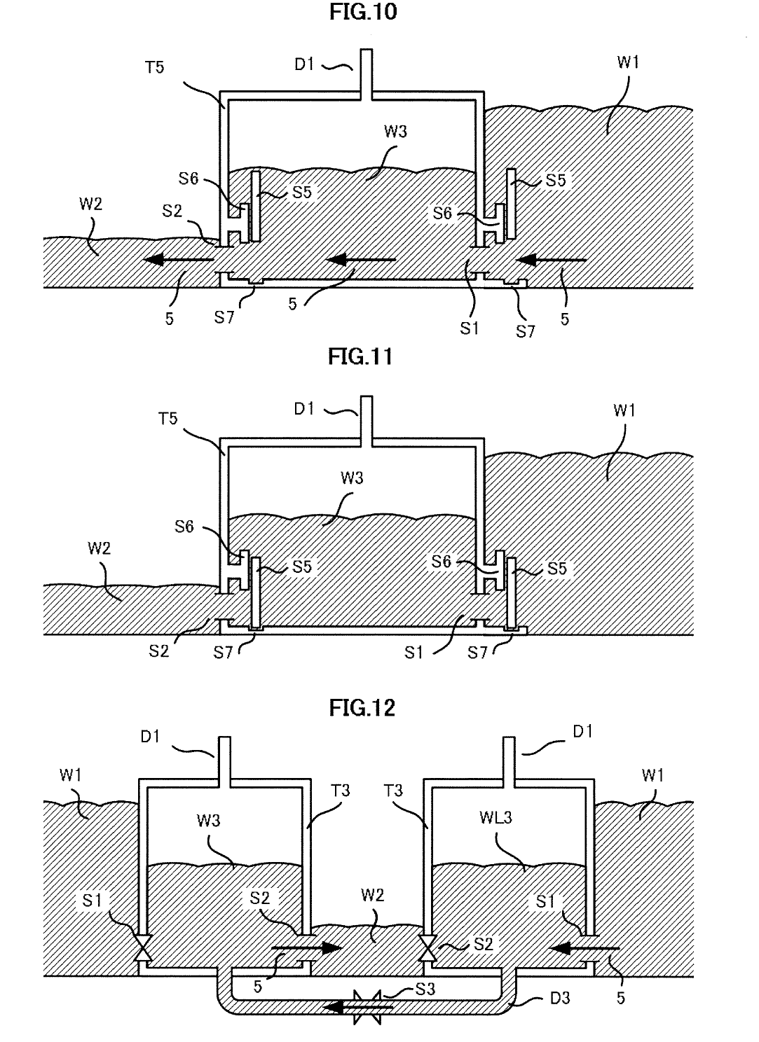

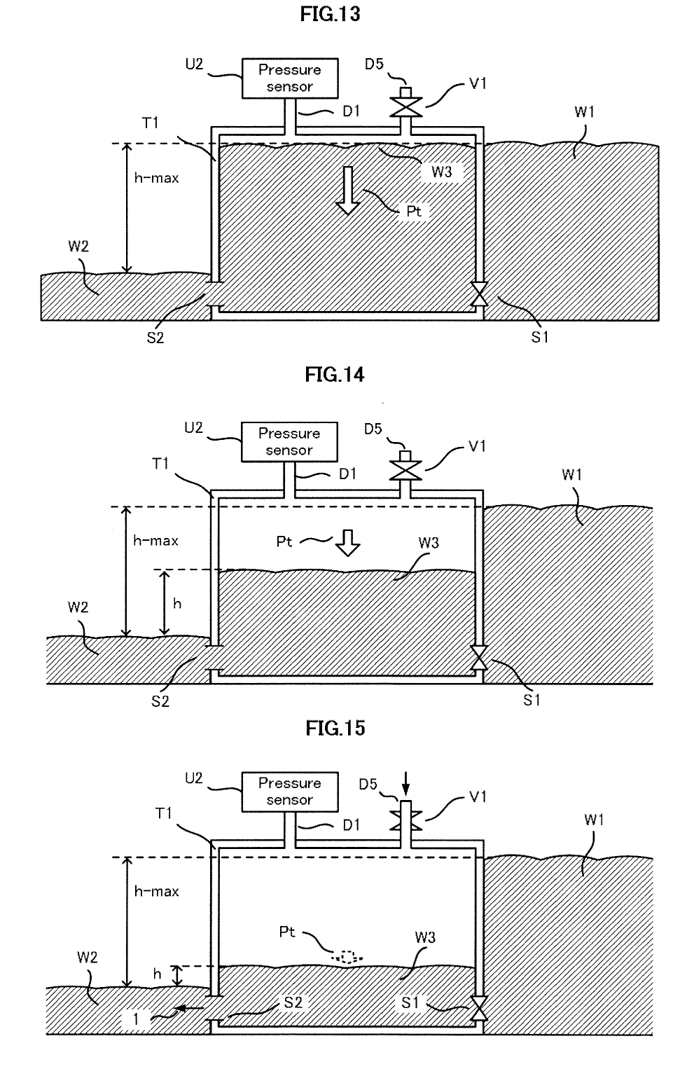

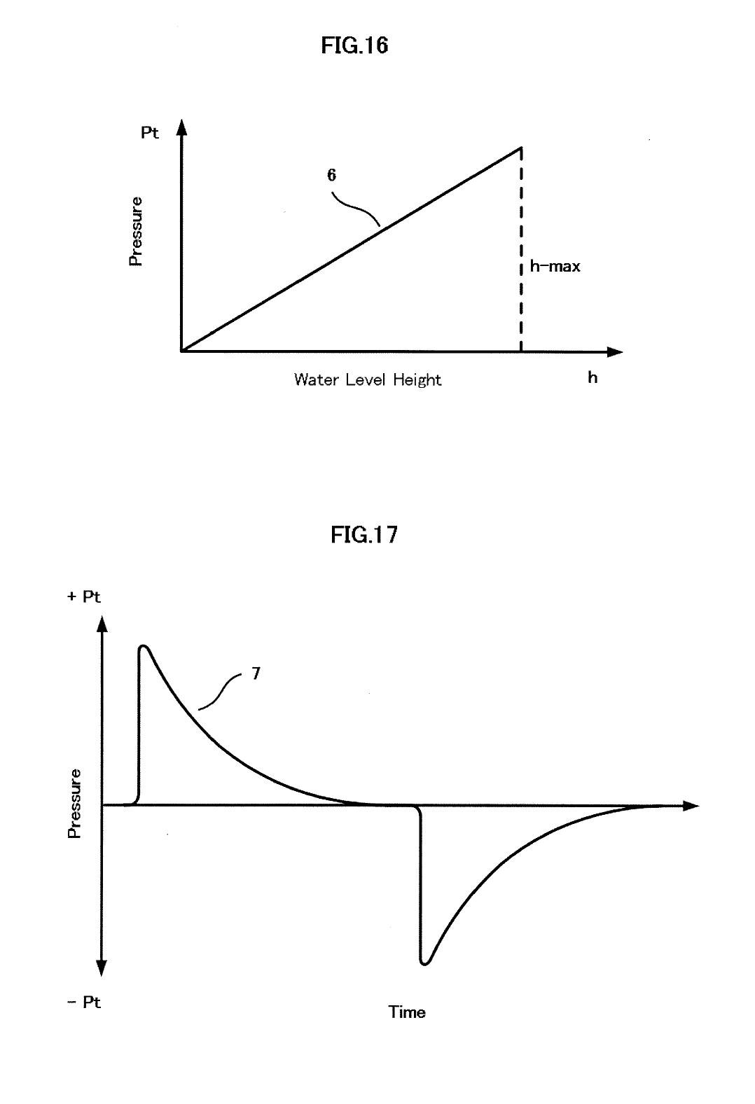

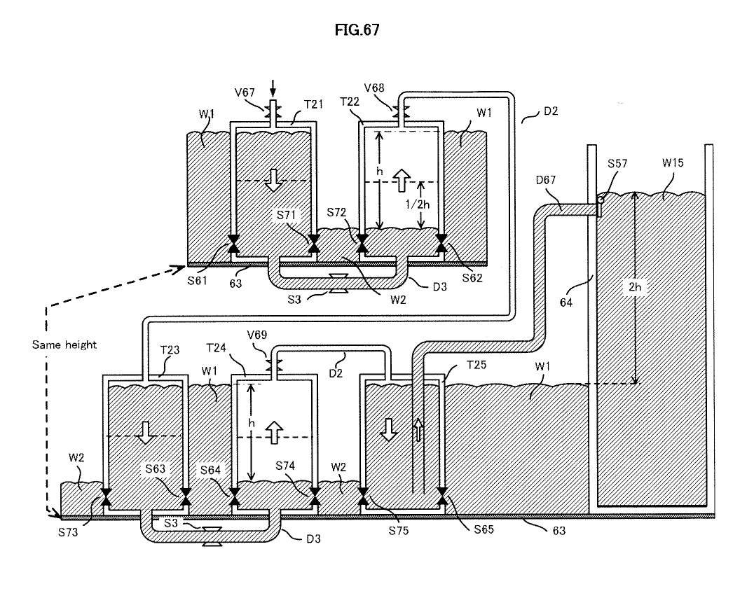

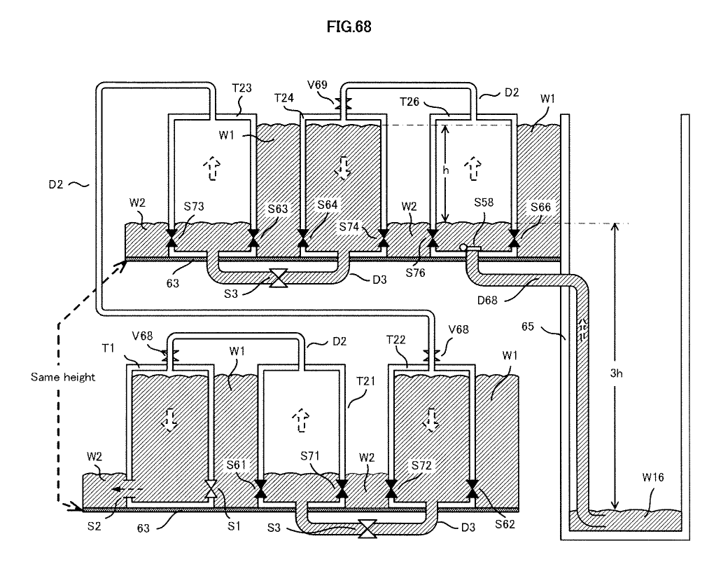

As for FIGS. 7-9, each 3rd Tank (T3) can make possible same feed-and-drain the 1st Tank (T1) if closed the Underwater Passage Valve (S3). First, as for the Pair 3rd Tank (T3), one 3rd Tank (T3) is set as the bottom of water, and another 3rd Tank (T3) is set as the full of water, as for the condition of having closed all Underwater Valves (S1, S2, S3), if opened the Underwater Passage Valve (S3), it is as follows by the pressure of the mutual water level difference in the Pair 3rd Tank (T3), as for 3rd Tank (T3), the Push-pressure occurs in one Open Air Duct (D1), and the pull-pressure occurs in another Open Air Duct (D1). As for FIG. 67 and FIG. 68, it is applicable as the mechanism adding the pressure if the Open Air Duct (D1) of the Pair 3rd Tanks (T3) is connected by series.

As for FIG. 9, the Underwater Passage (D3) can be located in a position higher than the Low Water Source (W2). The maintenance of the Underwater Passage Valve (S3) becomes easy if it is located on the upside water. As for the above, there is a case which the air mixes in Underwater Passage (D3), the mechanism which extracts the mixed air is needed for it. The bottleneck occurs with the flow of water if the air is in the Underwater Passage (D3). The position of Underwater Passage (D3) makes it higher than the Low Water Source (W2) and lower than the High Water Source (W1), the Underwater Passage Exhaust Passage (D6) with the Underwater Passage Exhaust Valve (V11) is set in the Underwater Passage (D3), and Underwater was connected the Underwater Passage (T3) is made full of water, then, the air is exhausted if opened the Underwater Passage Exhaust Valve (V11). Moreover, the Underwater Passage Exhaust Valve (V11) is closed after completing discharge of the air. Therefore, the air is eliminated from the Underwater Passage (D3) and function as the aqueduct will become available. In cases where the Underwater Passage (D3) becomes higher than the High Water Source (W1), it becomes possible to exhaust the air in the Underwater Passage (D3) by setting the Underwater Passage Exhaust Passage (D6) with the Underwater Passage Exhaust Pump (TU5).

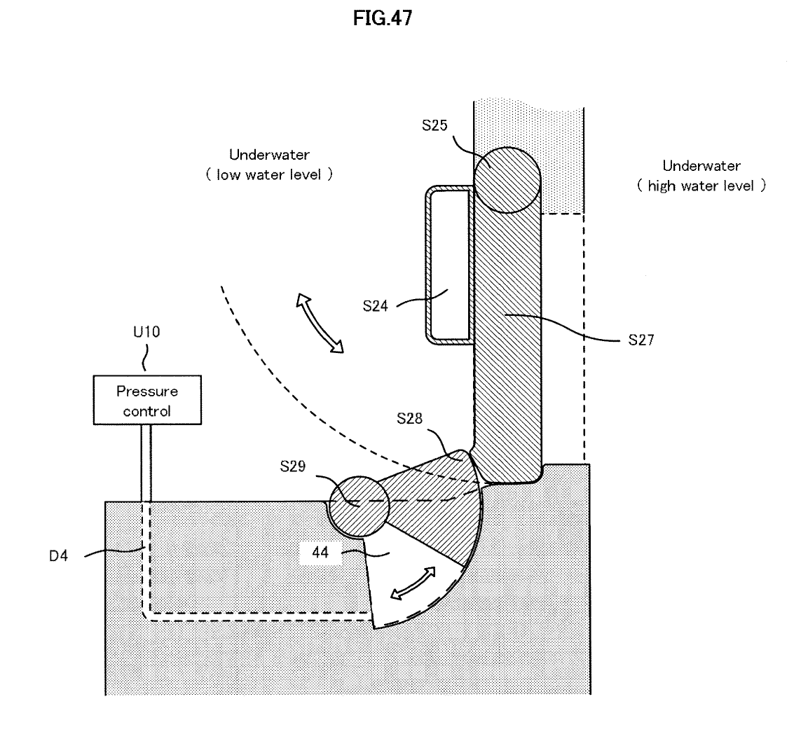

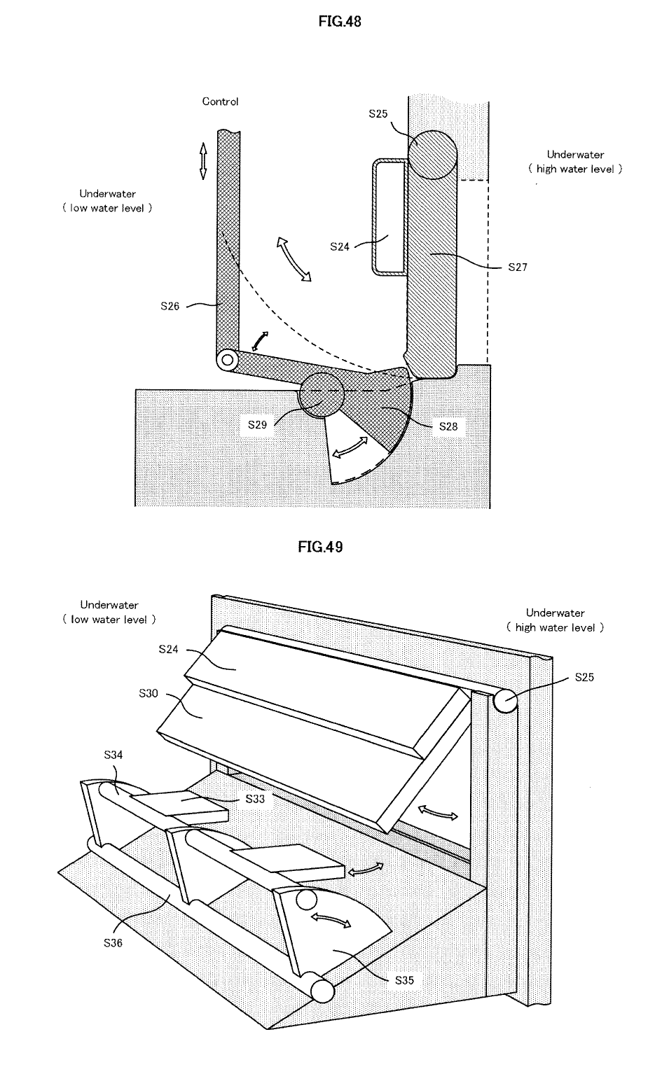

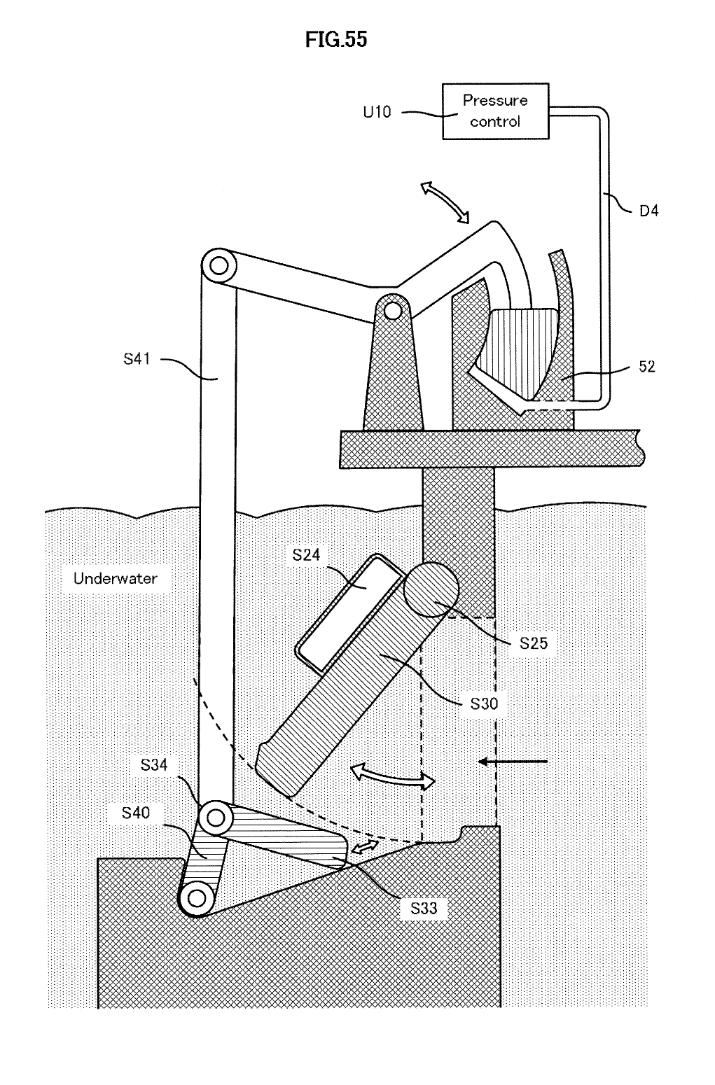

FIGS. 10-12 are explained below, as for the case where the Feed-and-Drain Valves (S1, S2) are the Locking Specific-gravity Valves (FIGS. 47-56), the Locking Specific-gravity Valve (FIGS. 47-56) cannot close it in the condition that the stream is continuing flowing because there may be no power for opening and closing the Plug-Part in this mechanism, as for the case where both the Feed Water Valve (S1) and the Drain Valve (S2) open at the same time, it becomes impossible to stop this flow because the Accident Flow which passes from the High Water Source (W1) to the Low Water Source (W2) occurs, As for FIG. 10 and FIG. 11 in this case, it is doubly set to the Feed Water Valve (S1) or the Drain Valve (S2), as for the Forced Closing Valve (S5) with the closing ability of that stream, it stream can be stopped if either feed water side or drain side is closed. FIG. 12 is explained below, as for the Pair 3rd Tank (T3), the Underwater Passage Valve (S3) is opened, an Accident Flow will occur if one the Feed Water Valve(S1) and another the Drain Valve (S2) of the 3rd Tank (T3) are open, as for this countermeasure, that Accident Flow can be stopped if the aforesaid Forced Closing Valve (S5) is used. The occurrence of this Accident Flow is detectable with the situation of the Underwater Valves, Even if it is except it, it is detectable by the strong stream, a stream without a water level variation, or the unexpected water level in a Tank. Even if the mechanism of this invention does not have the Valve Sensor, detection of an Accident Flow is possible for it.

FIGS. 13-15 are explained, the pressure of the Open Air Duct (D1) changes by the water level in the 1st Tank (T1). Hence, the water level difference of the opening-side Water Source (W2) to the Tank (W3) is proportional to the pressure in the Tank (Pt). The waveform of this water level difference and the Tank pressure (Pt) is shown in FIG. 16. The Pressure Load is connected instead of the pressure sensor (U2), the waveform which observes time progress with the Feed-Water Valve-Control and the Drain Valve-Control is FIG. 17. As for the 1st Tank (T1), the Push-pressure occurs in the water supply case, the Pull-pressure occurs in the drainage case, and therefore waveform (7) is reversed.

FIGS. 13-15 are explained, as for the case where the Pressure Load is connected instead of the pressure sensor (U2), the vigor of the flow becomes weak if there are few water level differences of the Tank water level (W3) and the Water Source (W2) of the open-valve side, moreover, the speed of the flow becomes slow when the Tank water level (W3) and the water level with the Water Source (W2) of the open valve side approach, because the Pressure Load limit the stream. For that reason, the pressure open valve (V1) of the Pressure Opening Duct (D5) is opened, and the pressure in the 1st Tank (T1) is opened, feed-and-drain of few water level differences is made to complete quickly as a result. As for the case where the turbine and the dynamo are connected instead of the pressure sensor (U2) in the figures, in few water level differences, rotation speed becomes slow and power generation efficiency worsens. Therefore, power generation is ended quickly and the production of electricity of the way which shifted to the next power generation improves. This few of this water level difference is the Unnecessary Procurement Water Level Difference. FIG. 8 is explained, as for the case where there are few water level differences of the Pair 3rd Tank of the mutual Tanks water level (W3) by which the Underwater Passage (D3) was connected, it is the Unnecessary Procurement Water Level Difference similarly.

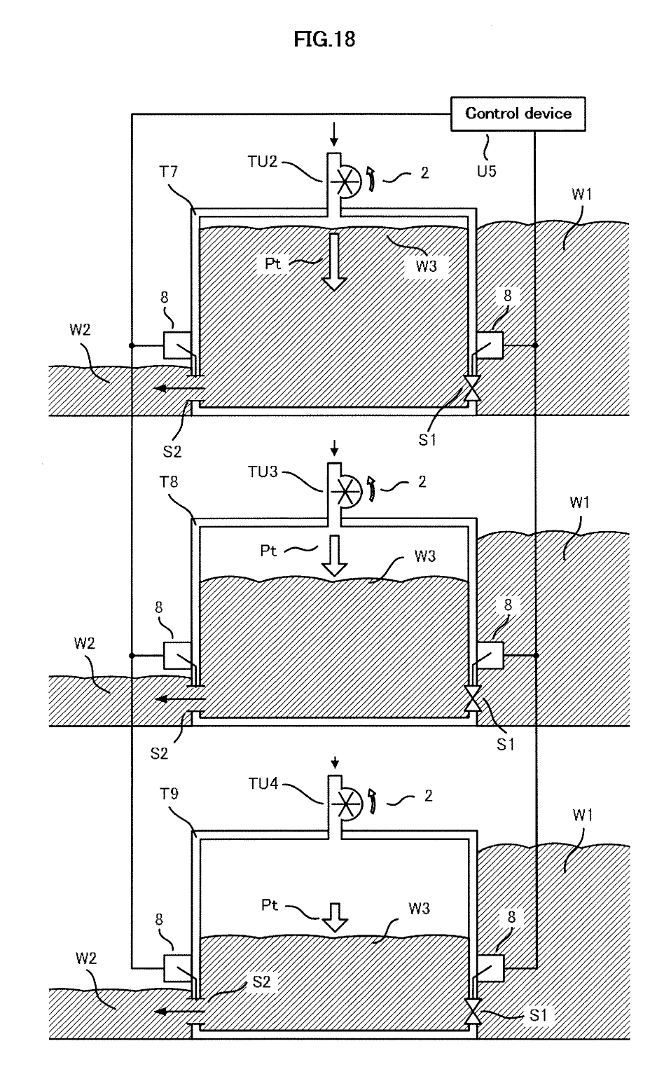

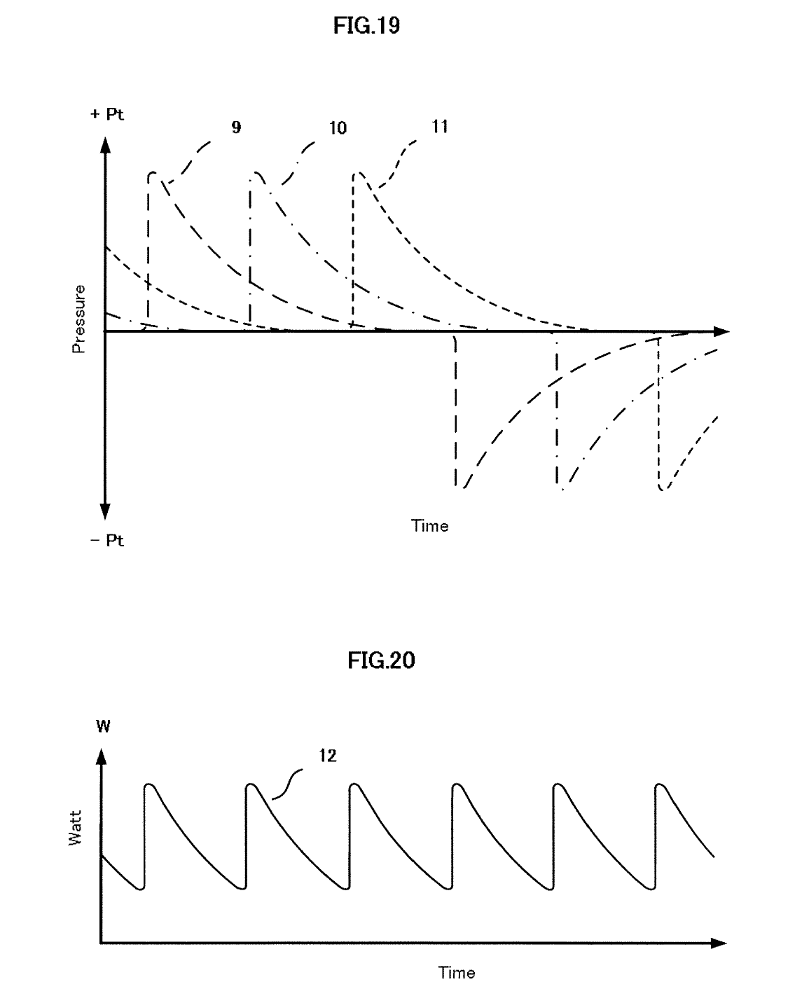

FIG. 18 is explained, parallel movement of the 1st Phase 1st Tank-the 3rd Phase 1st Tank (T7, T8, T9) is made by electronic control. Theoretical postulate of the cycle which feed water and drain exchanged is made at ½ cycle, that length is divided into one third, moreover, the open timing of the Feed-and-Drain Valves (S1,S2) of the 1st Phase 1st Tank-3rd Phase 1st Tank (T7, T8, T9) shifts ⅙ Cycle, and drives, as a result, the work (W) to take out becomes smooth, it is shown in FIG. 19 and FIG. 20. Program of the electronic control of this method is the Phase Difference Smooth Program. As for this Phase Difference Smooth Program, the water level sensor detects the water level of each water surface, the Valve Sensor detects the situation of each Underwater Valve, the 1st method makes electronic control of the Underwater Valve synthetically using such information, moreover, as for the second method, movement of the Feed-and-Drain Valves (S1, S2) is calculated by the Tank water level guessed in the time from the open valve, and it performs by program set up in that time.

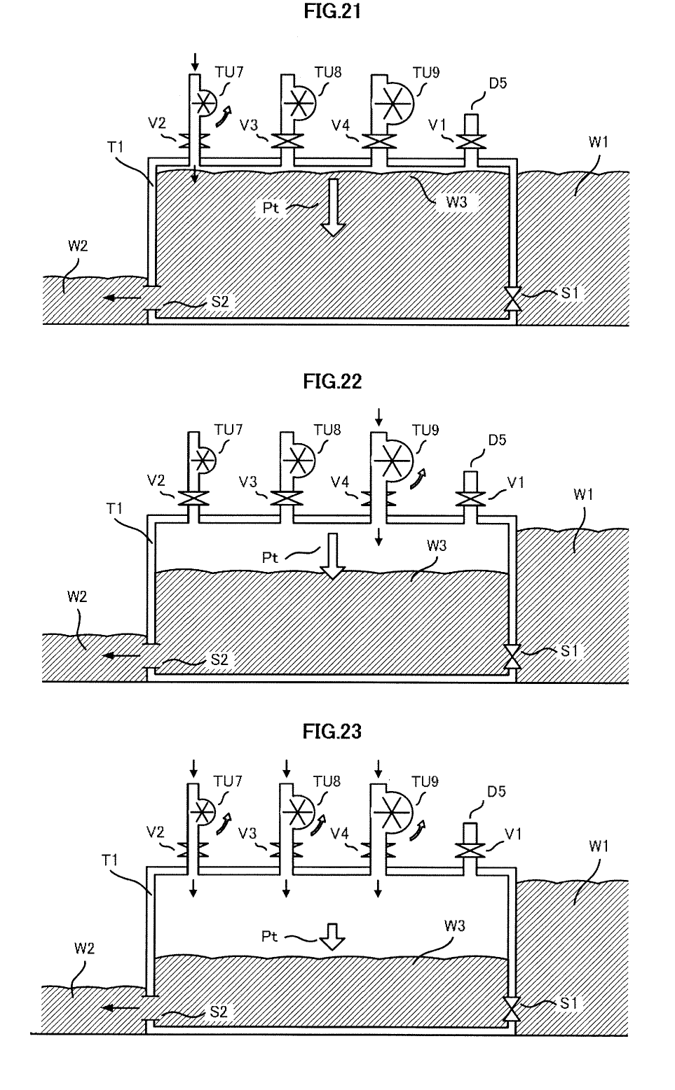

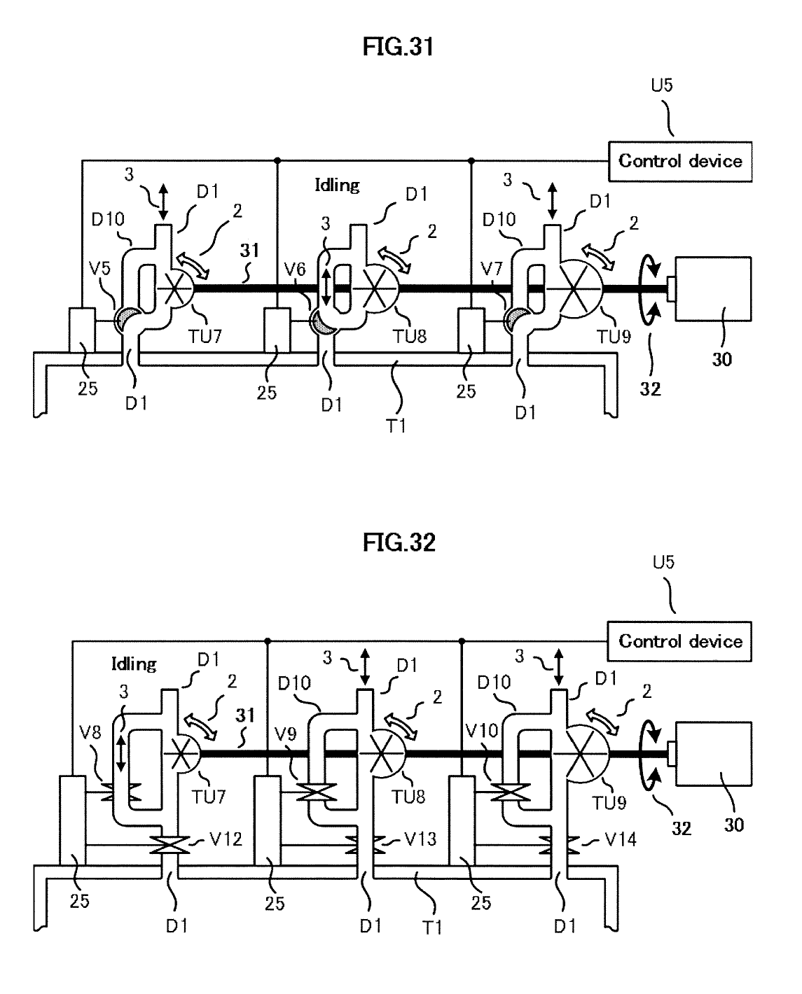

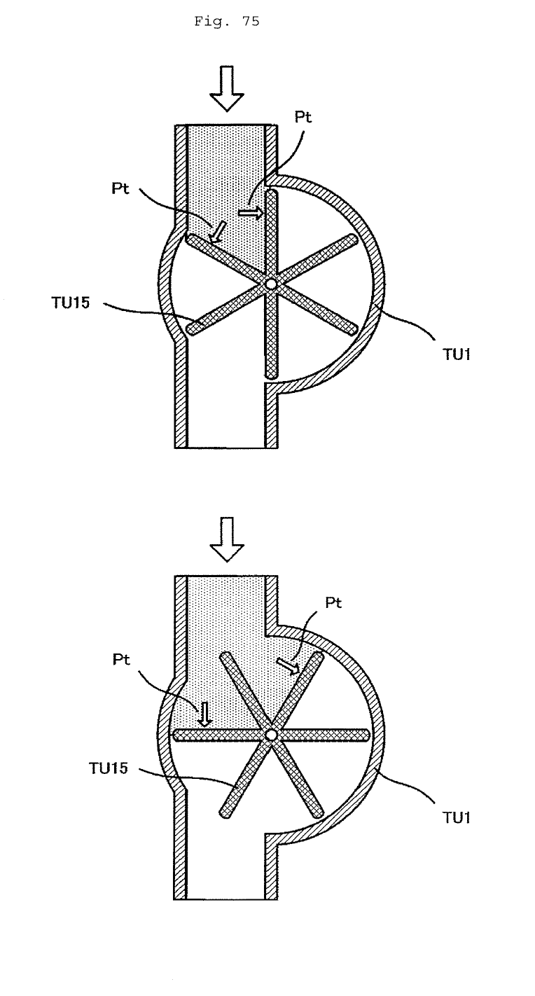

FIGS. 21-23 are explained, the energy (work) which can be taken out per unit of time will change, if the capacity of the turbine (TU7-TU9) which moves changes. Therefore, it will be possible to make smooth work which can be taken out, if the turbine is chosen according to the pressure change of the water level difference. FIGS. 31-33 have gathered torque, the dynamo (75) and the commutator (76) of FIG. 74 are formed set each turbine (TU7-TU9), as for the circuit which connected this to the battery (77), the aggregate of electric power is possible. Hence, not only torque but energies can gather in the turbine (TU7-TU9).

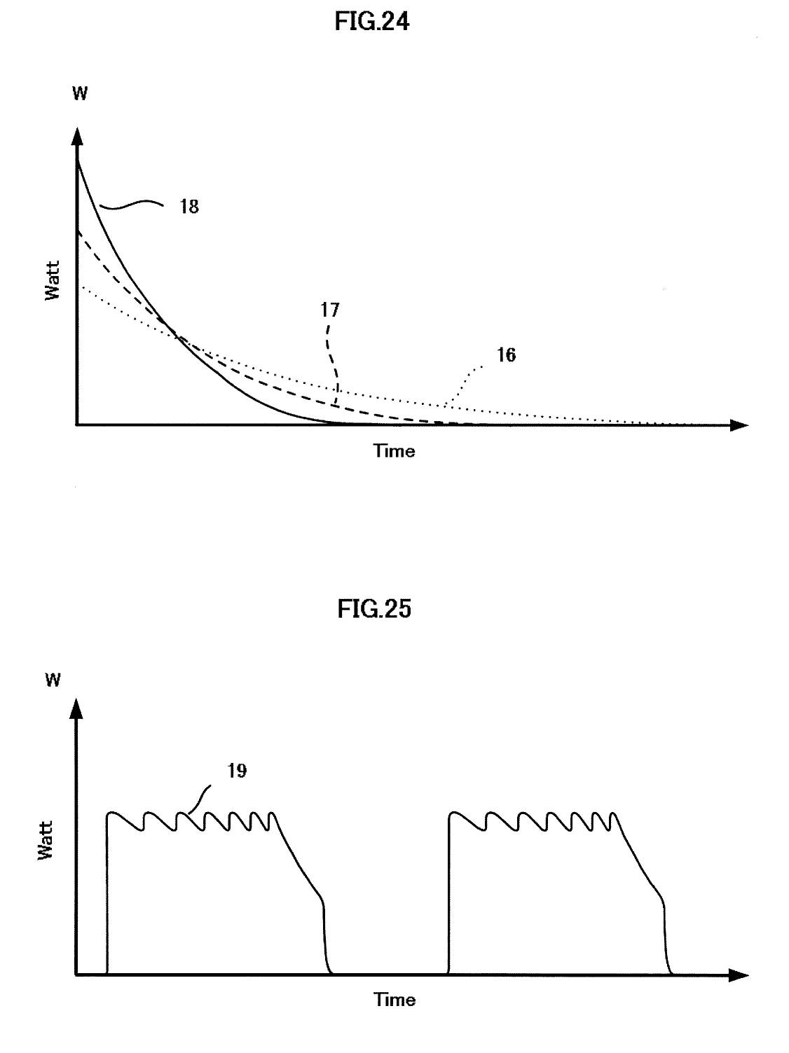

FIGS. 21-23 are explained, as for opening and closing of the Duct Valve (V2-V4), it works smoothly by choosing turbines (TU7-TU9) with the capacity difference, because the Tank Pressure (Pt) changes by the 1st Tank Water Level (W3). As for individual of each turbine, the waveform the case where work is got from the 1st Tank (T1) is shown in FIG. 24. (This figure is the comparison of awareness of turbine capacity, and is not the following ratio.) The following becomes theoretical description. Small Capacity Turbine (TU7)=A, Middle Capacity Turbine (TU8)=B, Large Capacity Turbine (TU9)=C, the capacity of one cycle of each turbine is A=1, B=2, and C=4. The capacity of the combination of selection of these turbines is A=1, B=2, A+B=3, C=4, A+C=5, B+C=6, A+B+C=7, seven steps of capacity can be set up as a result. The capacity (A, B, C) of these turbines are chosen responding the water level in the 1st Tank (T1), as for the feed water and drain, it becomes a waveform of FIG. 25, if the total capacity of the turbine changes and smooth work is got, about the reason why the close parts of feed water and drain are cut off, with the FIG. 25 waveform, that reason is influence of of movement of the Pressure Open Valve of FIGS. 13-15. The movement made to drive by the aforesaid turbines selection is the Selection Drive. The electronic control program in this method is the Displacement Optimization Program. The mechanism which gathers each work of the aforesaid turbine is shown in FIGS. 31-33.

It is possible to get the work in which both the Phase Difference Smooth Program and the Displacement Optimization Program performed smooth.

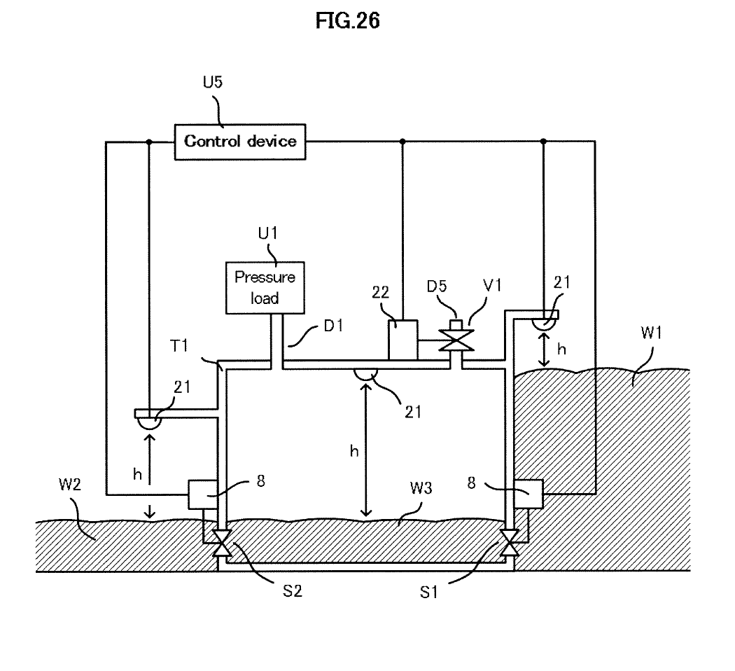

The Pressure Occurrence Mechanism of this invention is materialized only by the electronic control, moreover, it is materialized only by the attached peripheral device of FIGS. 26-29.

FIG. 26 is explained, the example of the steps of the consecution movement of the electronic control of the 1st Tank (T1) is shown below. A pressure occurrence point is the Open Air Duct (D1), and the Pressure Load (U1) is connected.
1, The Pressure Open Valves (V1) and the Drain Valves (S2) are closed.
2, The push-pressure occurs, if the Feed Water Valve (S1) is made open.
3, The Pressure Open Valve (V1) is opened at the Unnecessary Procurement Water Level Difference.
4, The completion of feed water.
5, The Pressure Open Valve (V1) and the Feed Water Valve (S1) are closed.
6, The pull-pressure occurs, if the Drain Valve (S2) is made open.
7, The Pressure Open Valve (V1) is opened at the Unnecessary Procurement Water Level Difference.
8, The completion of drain.
9, 1-8 are repeated.

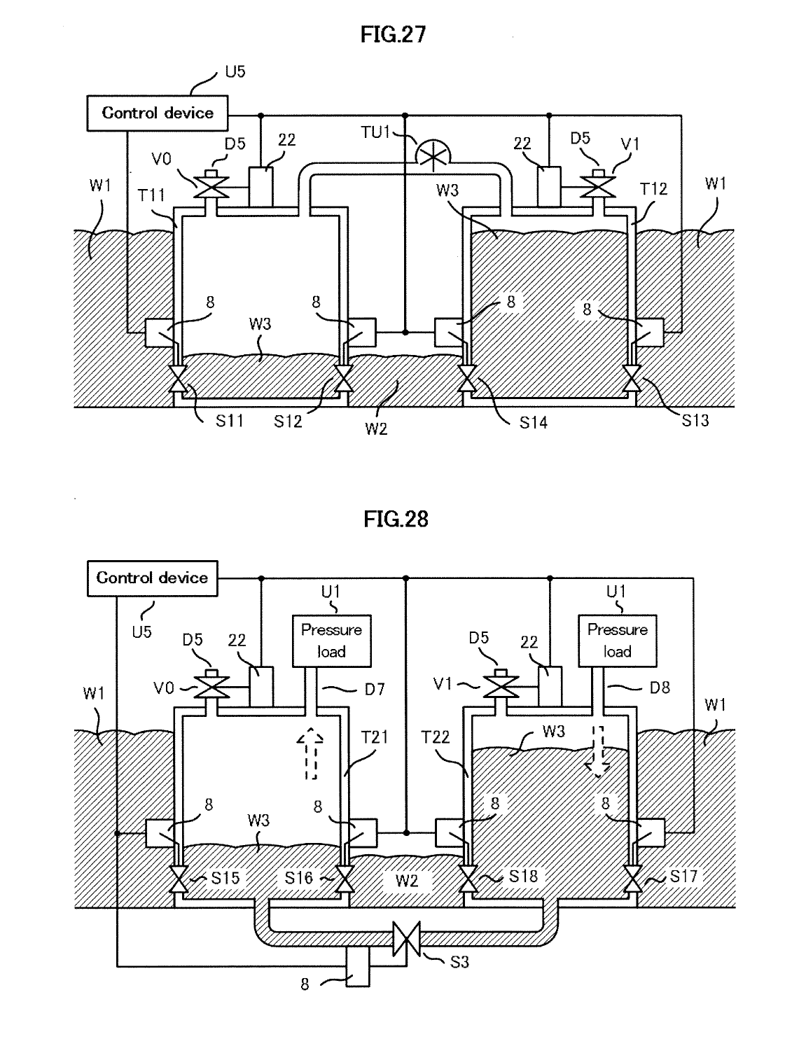

As for FIG. 27, the example of the steps of consecution movement of the electronic control of the Pair 2nd Tank (T11, T12) is shown below.
1, Both the Pressure Open Valves (V0, V1), and the Drain Valve A (S12) and the Feed Water Valve B (S13) are closed.
2, The turbine (TU1) rotates if the Feed Water Valve A (S11) and the Drain Valve B (S14) are opened,
3, Both Pressure Open Valves (V0, V1) are opened at the Unnecessary Procurement Water Level Difference.
4, The completion of feed-and-drain.
5, Both Pressure Open Valves (V0, V1), and the Feed Water Valve A (S11) and the Drain Valve B(S14) are closed.
6, The turbine (TU1) rotates, if the Drain Valve A (S12) and the Feed Water Valve B (S13) are opened.
7, Both Pressure Open Valves (V0, V1) are opened at the Unnecessary Procurement Water Level Difference.
8, The completion of feed-and-drain.
9, 1-8 are repeated.

As for FIG. 28, the example of the steps of the electronic control of the Pair 3rd Tank (T21, T22) is shown below.
1, The Underwater Passage Valve (S3), and the Feed Water Valve A (S15) and the Drain Valve B (S18) are closed.
2, Both Pressure Open Valves (V0, V1), and the Drain Valve A (S16), and the Feed Water Valve B (S17) are opened.
3, The 3rd Tank A (T21) becomes the bottom of water and the 3rd Tank B (T22) becomes full of water.
4, Both Pressure Open Valves (V0, V1), and the Drain Valve A (S16) and the Feed Water Valve B (S17) are closed. It is the completion of preparation of the pressure occurrence.
5, The pull-pressure occurs to the Open Air Duct A (D7), if the Underwater Passage Valve (S3) is made open, and the pull-pressure occurs to the Open Air Duct B (D8).

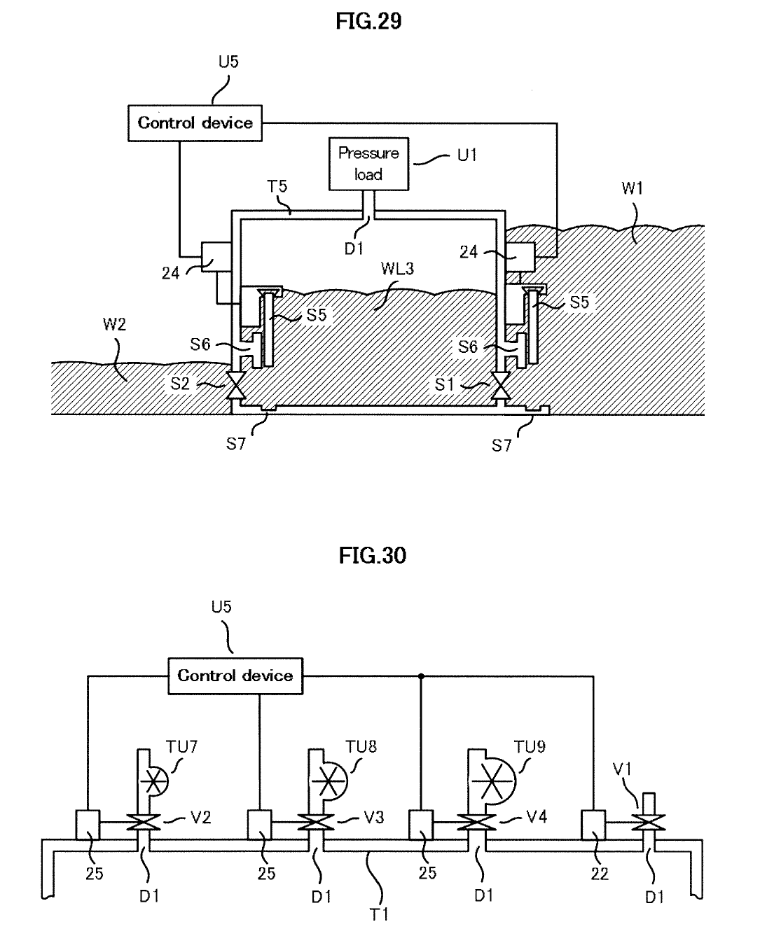

As for FIG. 26 and FIG. 27, the Forced Closing Valve of FIG. 29 is equipped, the example of the steps of the electronic control of the Forced Closing Valve (S5) of the 1st Tank (T1) and the simplex 2nd Tank (T11 or T12) are shown below. The 2nd Tank is equal to the 1st tank (T1) because the Air Duct can be disregarded.
1, Simultaneous opening of the Feed Water Valve (S1) and the Drain Valve (S2) is detected.
2, The Forced Closing Valve (S5) of the Feed Water Valve (S1) side or the Drain Valve (S2) side is closed.

As for FIG. 28, the Forced Closing Valve of FIG. 29 is equipped. The example of the steps of the electronic control of the Forced Closing Valve (S5) of the Pair 3rd Tank (T21, T22) are shown below.
1, Concurrent opening of the Feed Water Valve A (S15) and the Drain Valve A (S16) is detected.
2, Concurrent opening of the Feed Water Valve B (S17) and the Drain Valve B (S18) is detected.
3, Concurrent opening of the Underwater Passage Valve (S3), the Feed Water Valve A (S15), and the Drain Valve B (S18) is detected.
4, Concurrent opening of the Underwater Passage Valve (S3), the Drain Valve A (S16), and the Feed Water Valve B (S17) is detected.
5, As for the faulty detection by 1-4, the moved Forced Closing Valve (S5) of the Feed Water Valve side or the Drain Valve side is closed.

FIG. 30 is explained, the Duct Valve (V2-V4) of the capacity difference turbine (TU7-TU9) performs the Selection Drive. Small Capacity Turbine (TU7)=A, Middle Capacity Turbine (TU8)=B, Large Capacity Turbine (TU9)=C. Those capacity is A=1, B=2, and C=4. The above is set up, the selection drive of A, B, and C is performed. As for the water level difference of the 1st Tank Water Level (W3) to the opening-side Water Source, it is set as “Water levels 1-7” from that large order, the “water level 8” is made into the Unnecessary Procurement Water Level Difference. This Selection Drive is the Displacement Optimization Program, this example electronic control steps A (1-10) is shown below.
1, The Pressure Open Valve (V1) and the Drain Valve (S2) are closed, and the Feed Water Valve (S1) is opened, as a result, the push-pressure occurs to the Open Air Duct (D1).
2, The Selection Drive of A is performed by the water level 1.
3, The Selection Drive of B is performed by the water level 2.
4, The Selection Drive of A and B is performed by the water level 3.
5, The Selection Drive of C is performed by the water level 4.
6, The Selection Drive of A and C is performed by the water level 5.
7, The Selection Drive of B and C is performed by the water level 6.
8, The Selection Drive of A, B, and C is performed by the water level 7.
9, The Pressure Open Valve (V1) is opened by the water level 8, and the Selection Drive is reset.
10, The completion of feed water.
   About this continuation, Feed-and-drain is exchanged and becomes the same Selection Drive of the Duct Valve (V2-V4). The work of this Selection Drive becomes a waveform of FIG. 25.

The example of the steps of electronic control which made the parallel operation of Displacement Optimization Program and the Phase Difference Smooth Program is shown below. The Displacement Optimization Program performs the example of steps A (1-10) of the preceding clause. As for the structure of this mechanism, the mechanisms of FIG. 30 are located to the upside of three sets of the 1st Tanks (T7-T9) of FIG. 18.
1, The example of the step A of the Displacement Optimization Program of the 1st Tank (T7) is performed at 0/6 cycle.
2, The example of the step A of the Displacement Optimization Program of the 1st Tank (T8) is performed at ⅙ cycle.
3, The example of the step A of the Displacement Optimization Program of the 1st Tank (T9) is performed at 2/6 cycle.
   As for 4/6- 6/6 cycle, the feed-and-drain is exchanged, the steps of 1-3 are performed like the above. The 1st Tanks (T7-T9) of a shift-cycle performs synchronous driving, keeping this cycle.

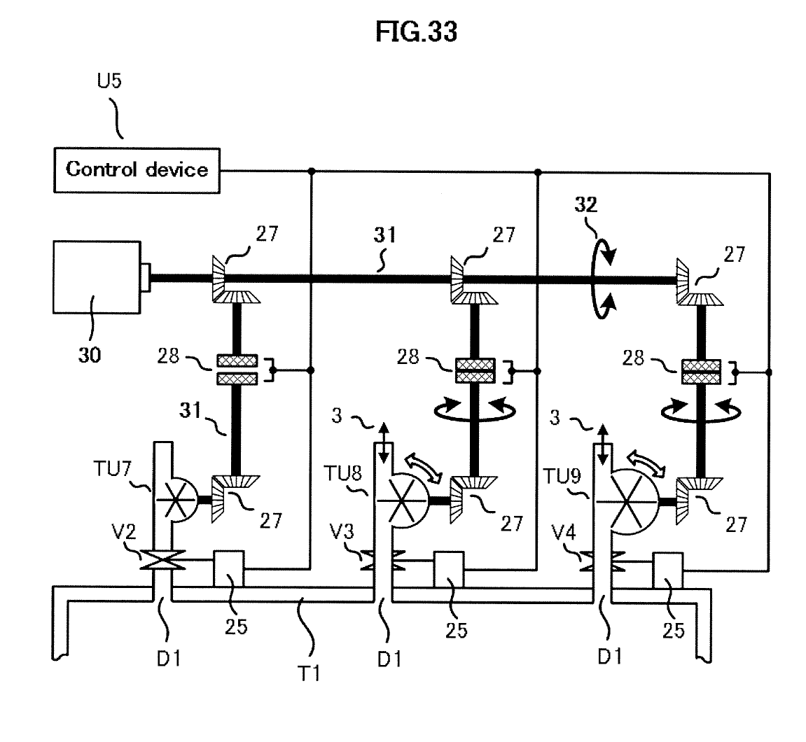

The examples of the aggregate of the torque of the Selection Drive are shown in FIGS. 31-33. As for the case where some turbines (TU7-TU9) are the Rotation Connection by the Selection Drive, the total capacity of that turbine (TU7-TU9) is proportional to torque. The pressure put to the turbines (TU7-TU9) is stopped with the valves, and the Rotation Connection is isolated, or it will not be Selection Driven if the turbine (TU7-TU9) is idled. FIG. 31 and FIG. 32 are explained, the axis of each turbine (TU7-TU9) is Rotation Connection with the Rotation joint shaft (31). If one of turbine rotates, all the turbines (TU7-TU9) rotate. If the Feedback Air Duct (D10) air-passes, the load put to the turbine will be lost, and the Selection Drive will become invalid by idling. If the Feedback Air Duct (D10) is closing and the Open Air Duct(D1) is the Air-passes, the pressure is added to the turbine, and the torque occurs, as a result, the Selection Drive becomes available. FIG. 31 is explained, if the Open Air Duct (D1) and the Feedback Air Duct (D10) are changed by the Change Valve (V5-V7), the Selection Drive can be performed. FIG. 32 is explained, as for the Open Air Duct (D1) and Feedback Air Duct (D10), if they are changed by interlocking of the Duct Valves (V12-V14) and the Feedback Valves (V8-V10), the Selection Drive can be performed. As for FIG. 33, if the torque of the turbines (TU7-TU9) is changed by interlocking of the Duct Valves (V2-V4) and the electric clutches (28). The Selection Drive is available by the Duct Valves (V2-V4) opening and the clutch connection, the Selection Drive is invalid by the clutch separation and the Duct Valve (V2-V4) closing.

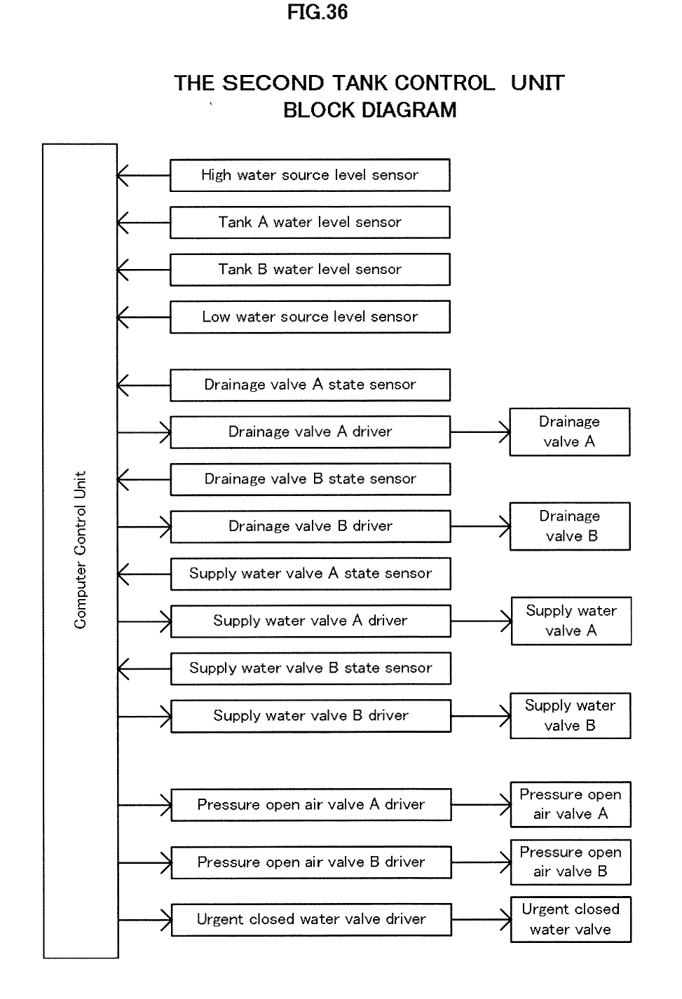

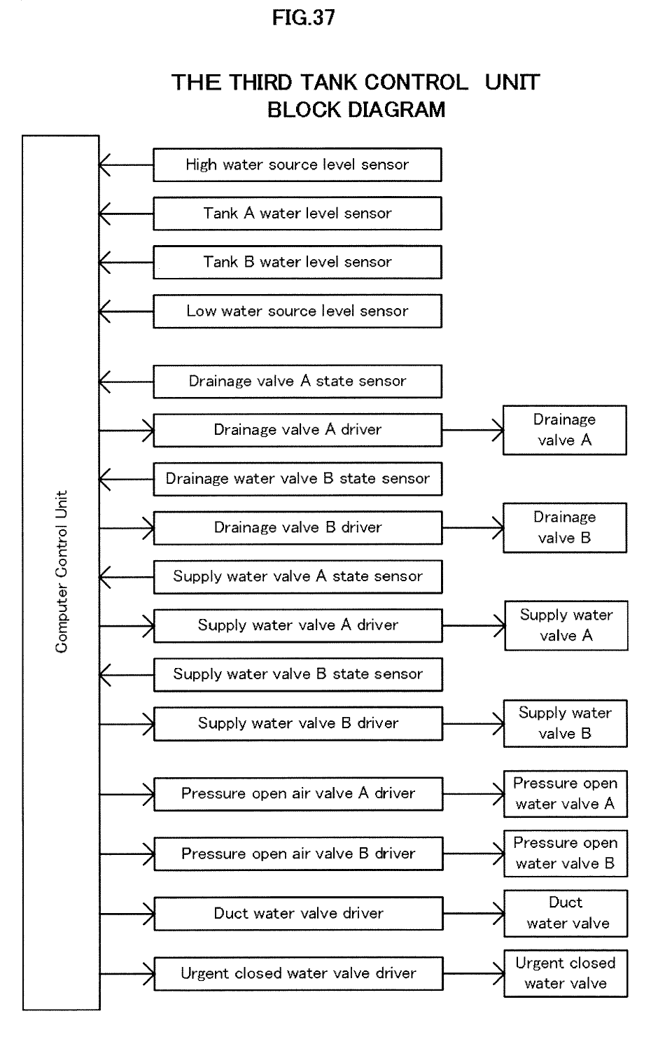

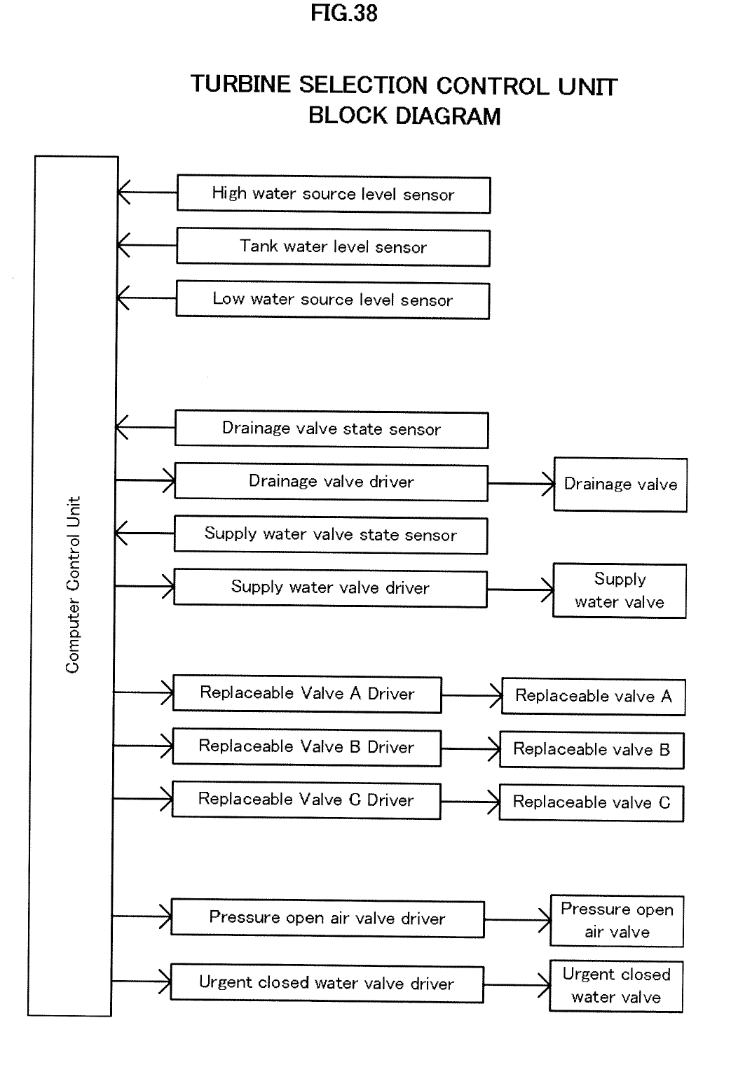

FIGS. 26-38 are explained, the Valve Driver (8, 22, 24, 25) is a driver of the electronic control which moves a valve, a relay and a semiconductor device are applicable to it.

As for the aforesaid content of control, if the water level difference of a Water Source, the aperture cross-section area of the Underwater Valve, and the Tank capacity and the turbine capacity are fixed quantity, the water level in a Tank is decided by time from the beginning of feed water or drain. Although the capacity of a turbine changes, if the period and the selected turbine capacity were decided, a water level is determined by the time. Therefore, it is even if there is neither the water level sensor nor the valve sensor, it is possible to move this mechanism only by control by the time.

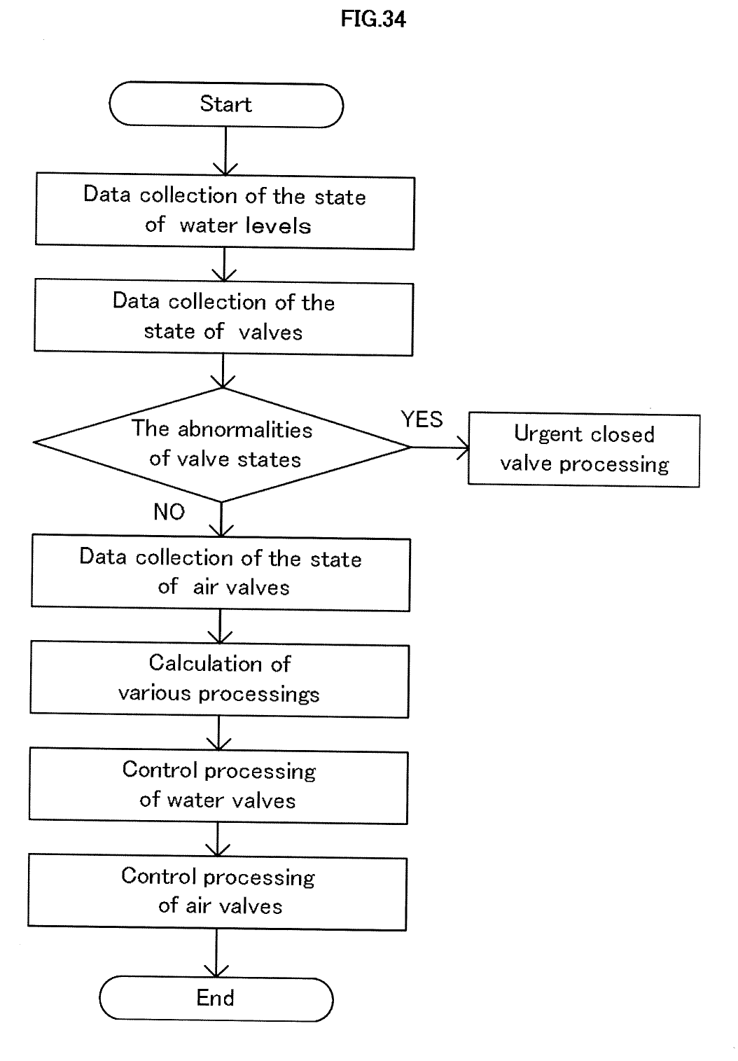

As for the example of the electronic control of the Tanks, such as detection of the water level of the Water Source, it is the steps of the software of flowchart which is shown in FIG. 34.

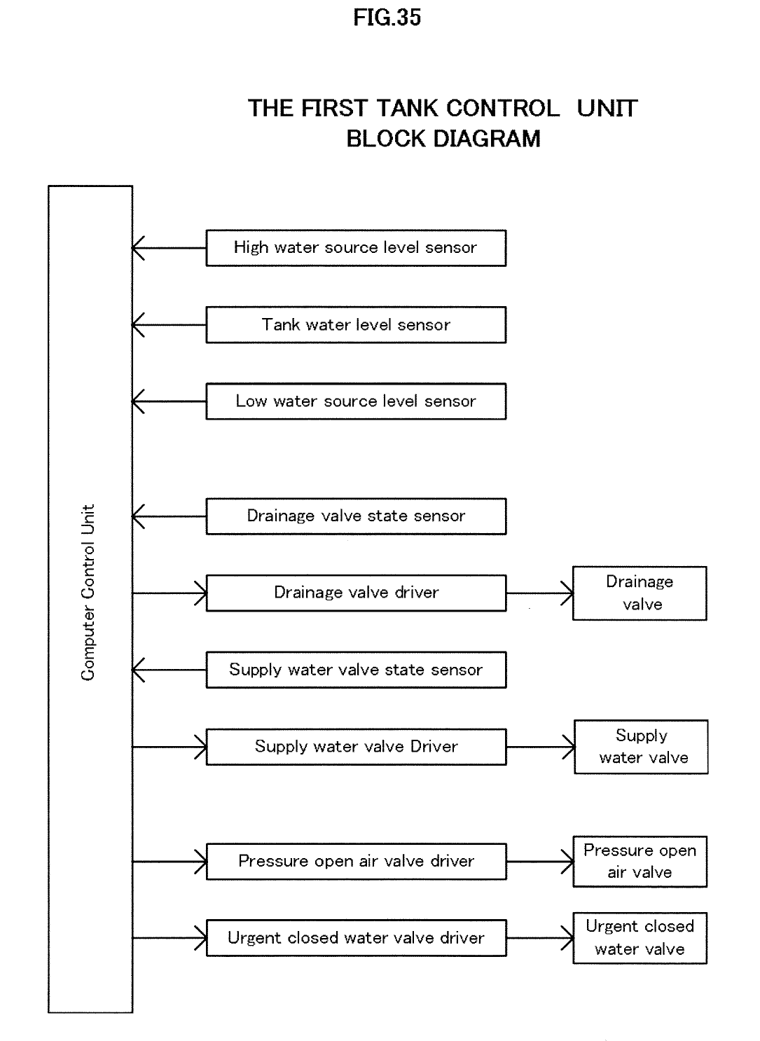

As for the mechanism of the electronic control of the 1st Tank-the 3rd Tank, the block diagram of basic constitution is shown to FIGS. 35-38.

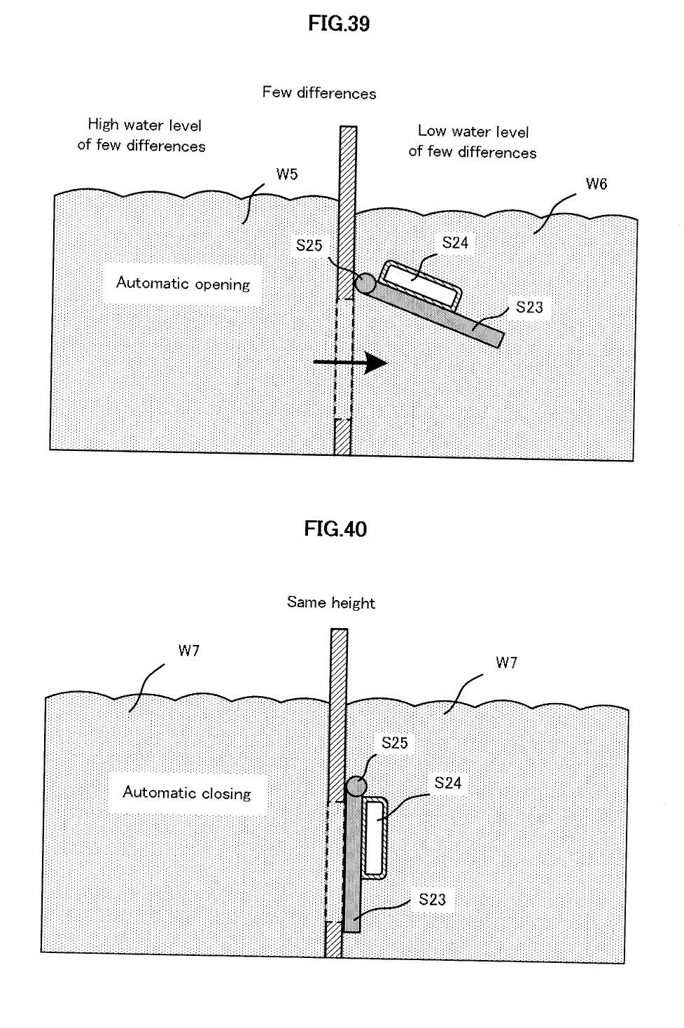

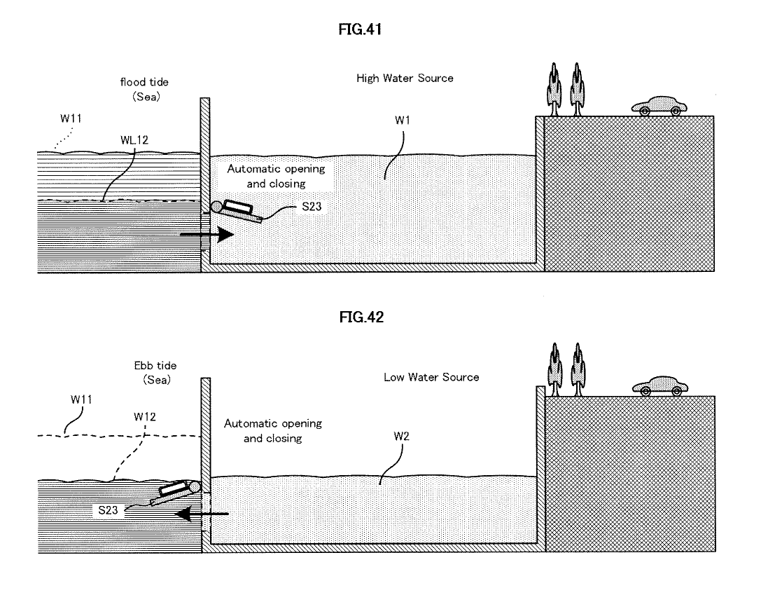

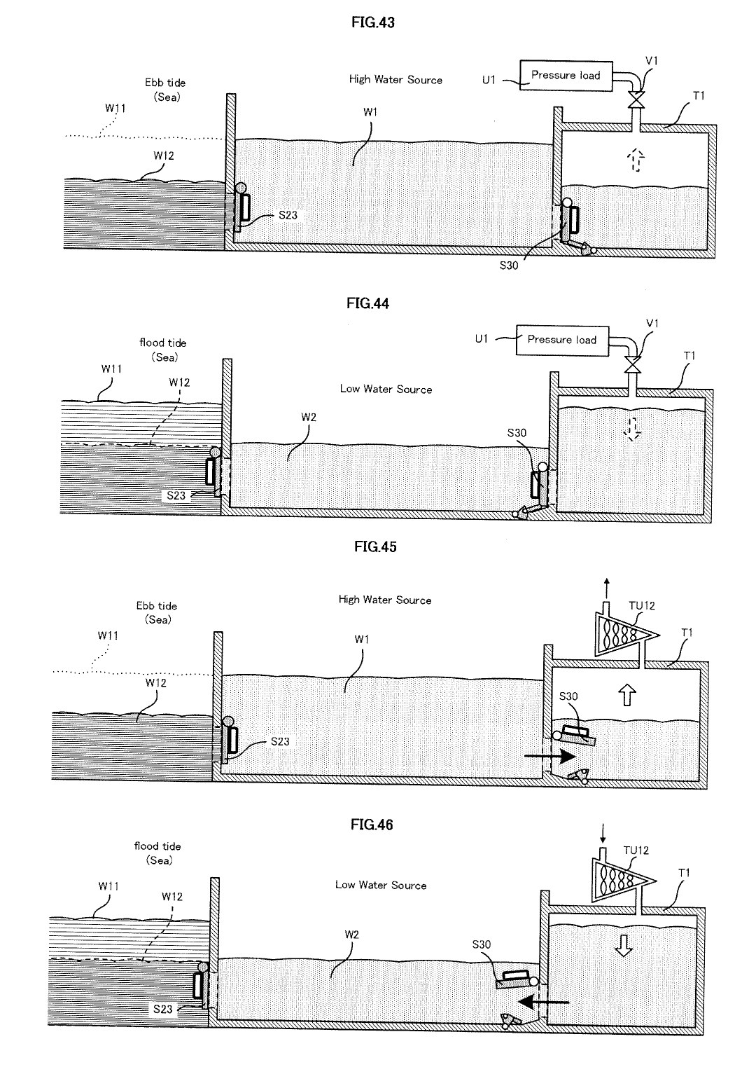

FIG. 39 and FIG. 40 are explained, as for the change water level environment which can make the water level difference, the Specific-gravity Valve (S23) is set in the underwater wall between a tide level and the Water Source. The Specific-gravity-Regulating Float (S24) is set on this Specific-gravity Valve (S23), the specific-gravity of this is slightly heavier than water. When there is no stream, the Specific-gravity Valve (S23) closes by self-weight slowly, and if there are few streams of the directions of an open-valve, the Specific-gravity Valve (S23) is pushed by the flow and opened. For this reason, the Specific-gravity Valve (S23) can become the Non-return Valve which reacts with few water level differences. This Specific-gravity Valve (S23) is set between the Water Source and the tide level, if it makes the open direction into the Water Source side, a water level flows in to the highest position of high tide, because it closes if that highest position falls, the High Water Source (W1) can be made as a result. If the open direction of this Specific-gravity Valve (S23) is made into the tide level side, the water level is flowed out to the minimum water level of ebb tide, because it closes if that minimum position goes up, the Low Water Source (W2) can be made as a result. Hence, this Specific-gravity Valve (S23) can become the Water Source Valve. According to the above, as for FIGS. 41-46, this Specific-gravity Valve (S23) can make the Water Source of the 1st Tank-the 3rd Tank of this invention.

FIG. 39, FIG. 40, and FIG. 47 are explained, the Specific-gravity Valve (S23) to which the Specific-gravity was adjusted can be used for the Locking Specific-gravity Valve (S27) for feed-and-drain. As for the characteristic of feed-and-drain of the Tank of this invention, there is the water level difference to the opposite side of the Plug-Part of the Feed-and-Drain Valve of opening, the open valve is performed where pressure is exerted. As for the case of closing of that valve, Feed-and-drain is completed and it will be in the condition that there is no water level difference. This Locking Specific-gravity Valve (S27) becomes mechanism of locking opening. As for the Locking Specific-gravity Valve (S27) which the pressure of the high-water side is added, it holds by straight line locating of the tip of the Locking rotation piston (S28) and the Locking axis of rotation (S29). As for the open valve, if pull-pressure is added to the locking cylinder (44), locking of the Locking Specific-gravity Valve (S27) can be canceled. As for this Locking Specific-gravity Valve (S27), the Locking Specific-gravity Valve (S27) is opened only by release of locking, and the stream flows by the pressure from the high-water side, if the stream stops at completion of feed-and-drain, it closes by own weight. Push-pressure is added to the Locking cylinder (44) after the completion of closing, and the locking rotation piston (S28) is made to drive and it locks. As for power generation of the low water level difference of this invention, if the Underwater Valve is not the big Flow Path, it cannot obtain big electric power. If it is this Locking Specific-gravity Valve (S27), the Underwater Valve of the big flow can be comprised.

FIG. 48 is explained, as for locking and release with a locking rotation piston (S28), it is possible to drive from upside water using the upside water Locking Axis (S26).

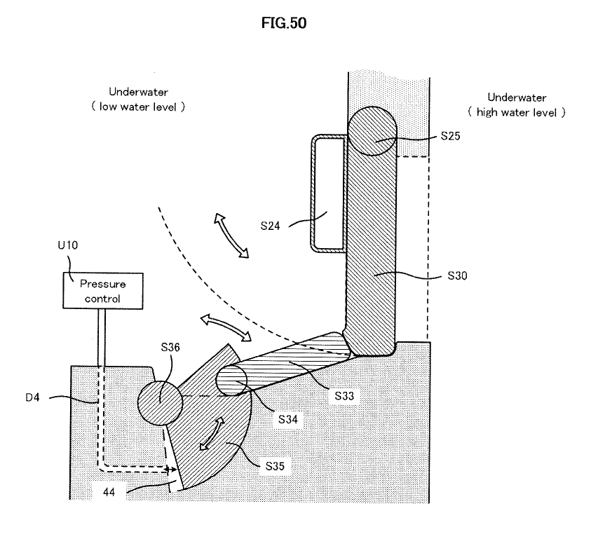

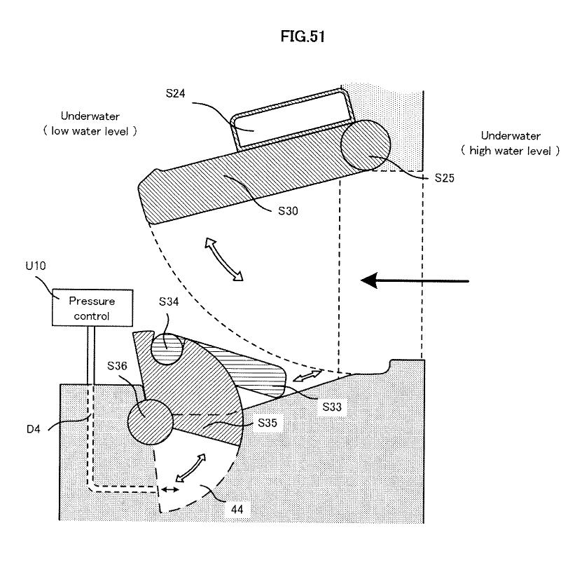

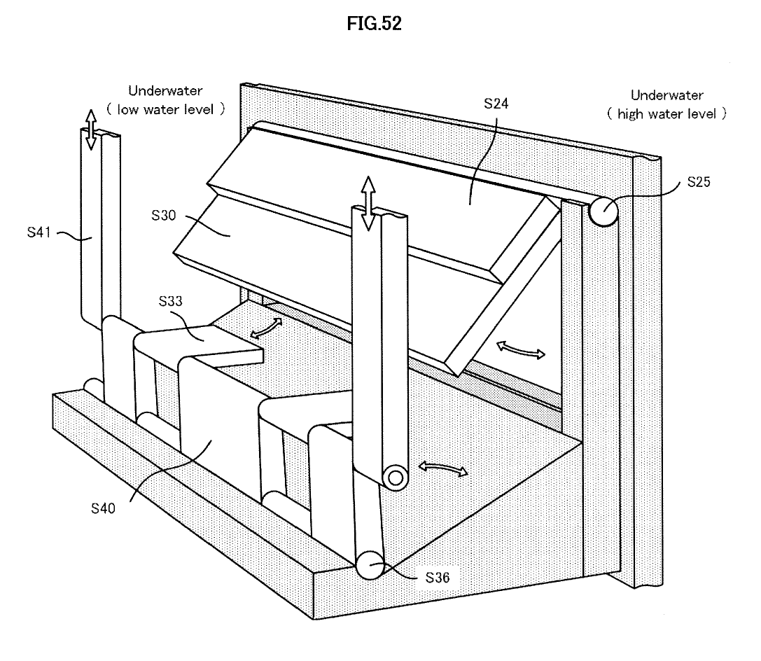

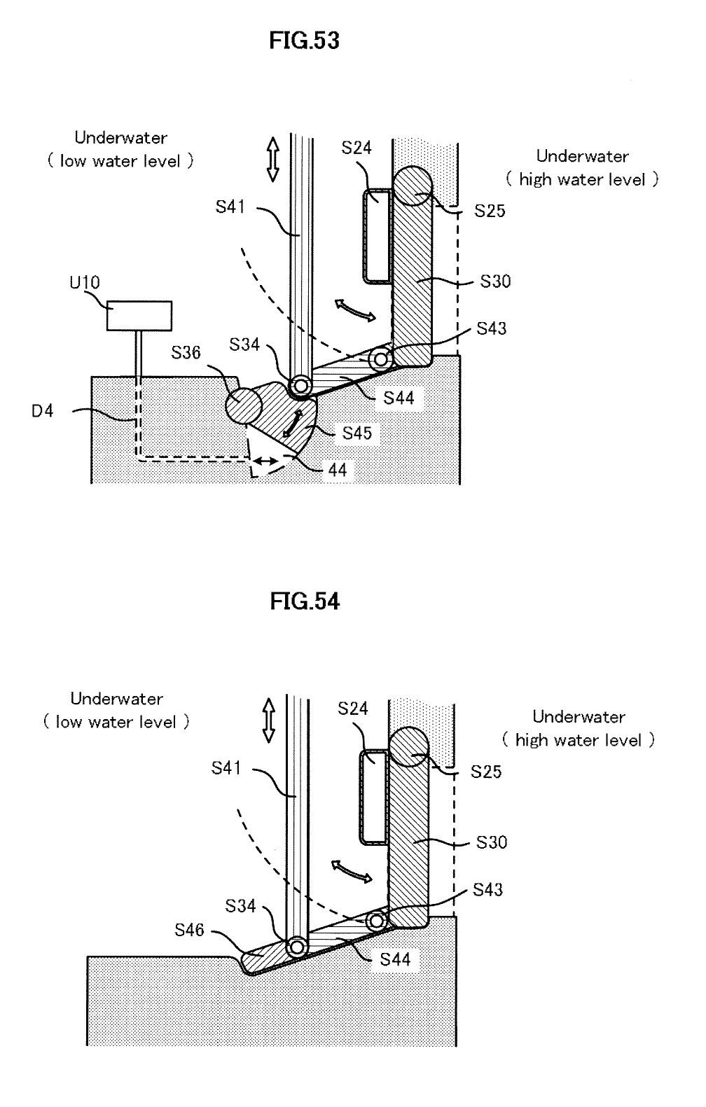

The “crank” of this invention is explained, as for in cases which two sticks have been located in a straight line, this is strong to the compressive force from the directions of both edges, if the linear mode collapses, it will break by weak power, it will become FIGS. 49-55 if the locking mechanism of FIG. 47, FIG. 48 is made into Crank structure. As for structure of the Crank Locking Specific-gravity Valve (S30) of FIG. 49, if it is structure which the Locking Protrusion (S33) and the Crank Locking Rotation Piston (S35) hold in a straight line, it holds the pressure of the water level difference of the Crank Locking Specific-gravity Valve (S30). Moreover, when open, the crank's bending enables it to cancel by weak power. In FIG. 50 and FIG. 51, if push-pressure is added to the locking cylinder (44), it will become canceled. FIG. 52 is explained, as for the Crank upside water Locking Axis (S41), if the Locking Protrusion (S33) is driven on upside water, it will make locking and release. FIG. 53 is explained, as for the Specific-gravity Valve Locking Axis (S44) of the crank part and the Locking Rotation Piston (S45), in the case of locking, the crank part will become in the mesh situation, and it is the structure which is separated in release. FIG. 53 and FIG. 54 are explained, the Crank upside water Locking Axis (S41) is attached to the Crank Locking Specific-gravity Valve (S30) side, release and locking can be performed in an upside water operation.

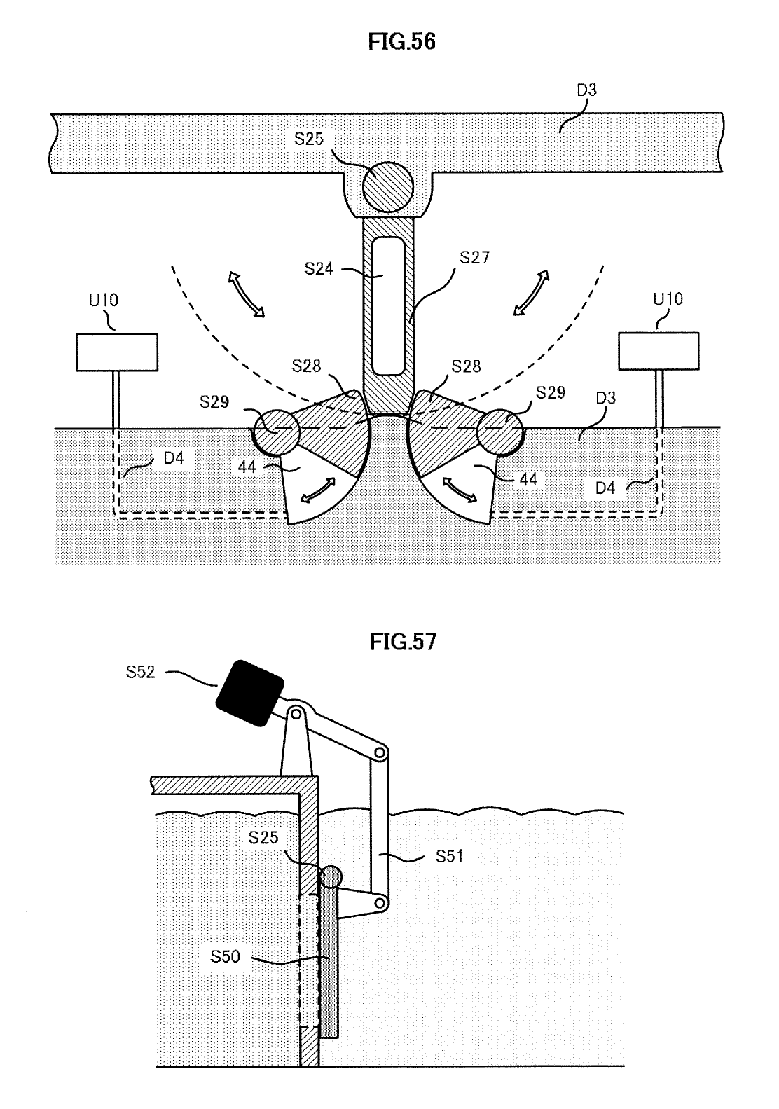

There are uses of the flows of one directions and both directions to the Underwater Passage Valve (S3) of the Underwater Passage (D3) of the Pair 3rd Tank, bidirectional opening and closing are possible for the Locking Specific-gravity Valve of FIG. 56. As for FIG. 56, opening prevention locking is made for the Locking Specific-gravity Valve (S27) from both directions, it can be opening and closing to both directions.

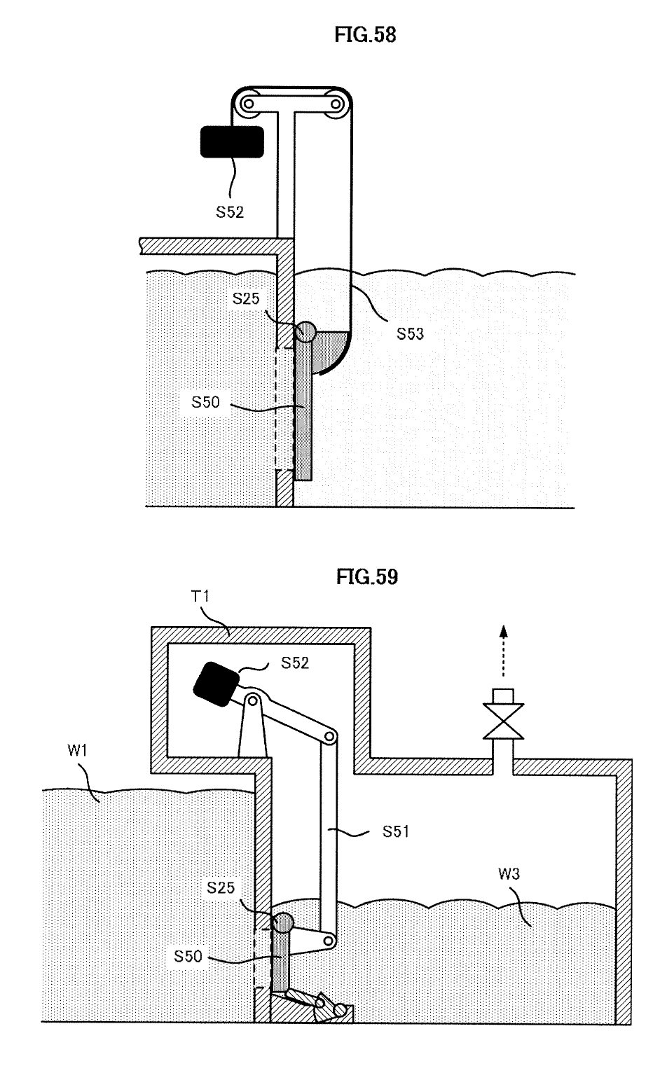

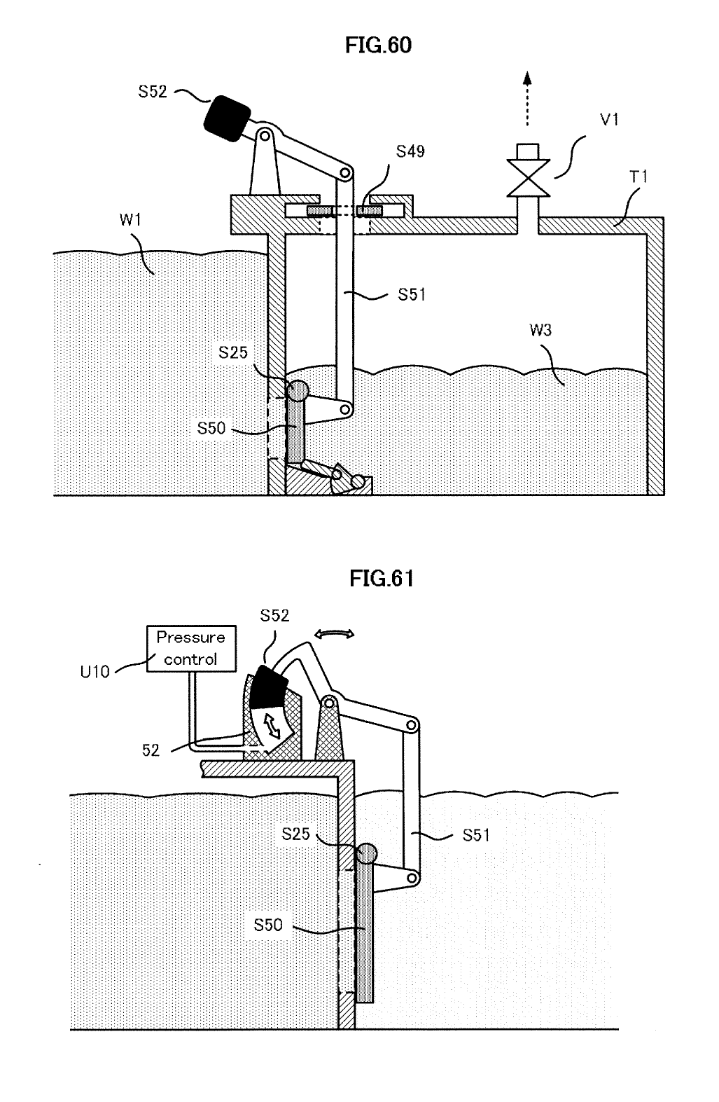

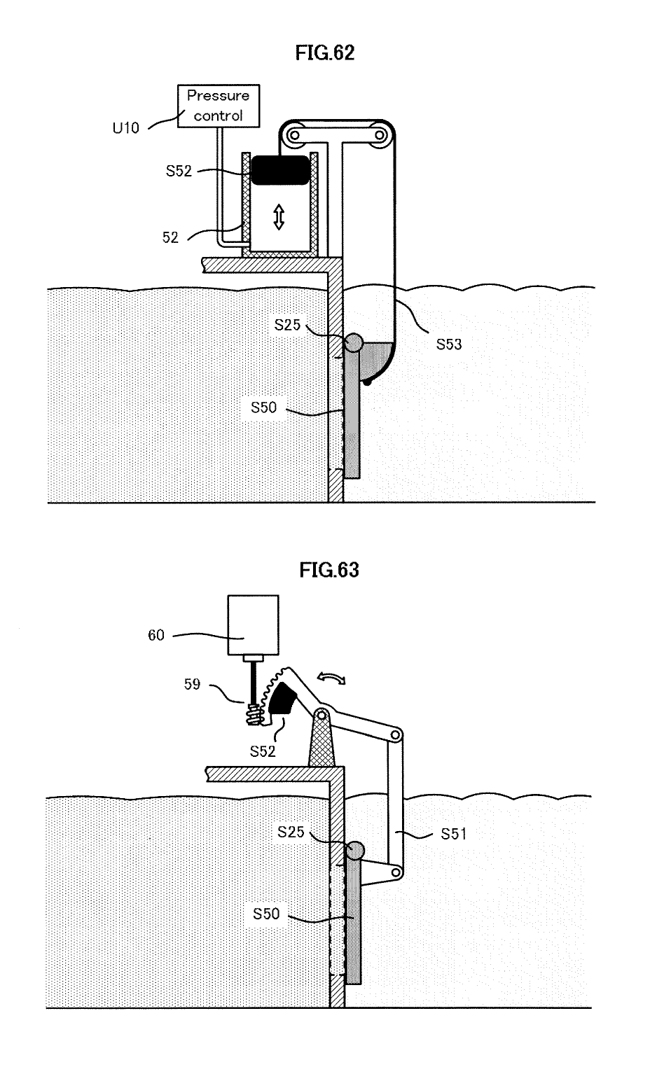

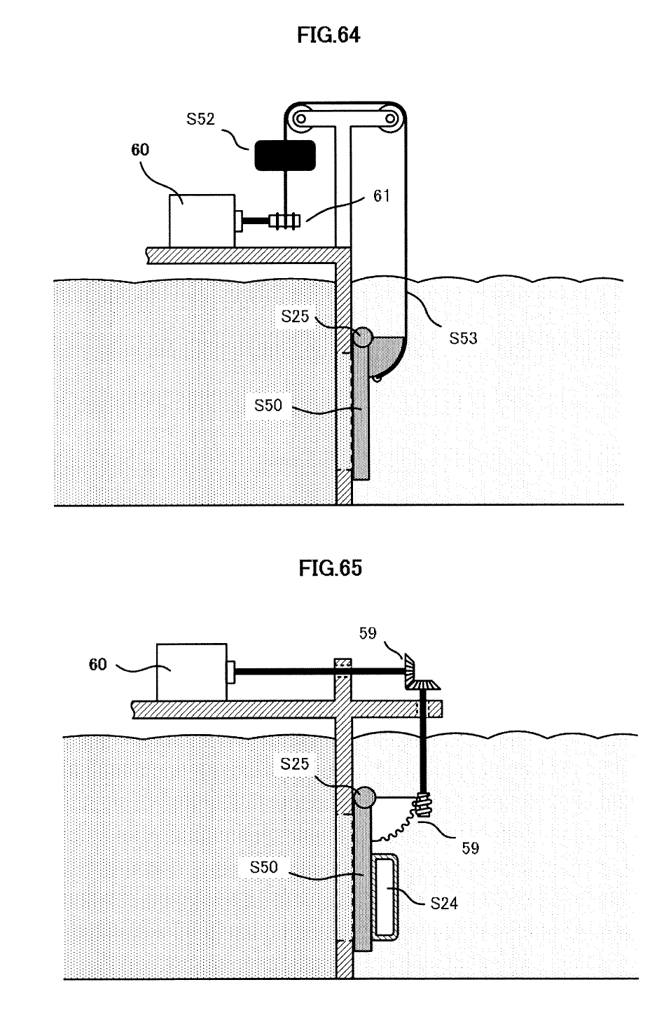

As for ways other than aforesaid Specific-gravity-Regulating Float (S24) of the Underwater Valve, there is another method to which the Specific-gravity of the Underwater Valve is made to approximate the Specific-gravity of water. As for the weight (S52, S56) of upside water of a pulley or seesaw structure, the mechanism of the Underwater Valve driven to the open directions is set in it, if the Underwater Valve sets it as it weight that balances more heavily than water, it becomes possible to comprise the Specific-gravity valve. This structure is shown in FIGS. 57-64 and FIG. 66.

As for FIGS. 61-66 of aforesaid structure, upside water driving force can opening and closing, and upside water mechanism has an advantageous maintenance.

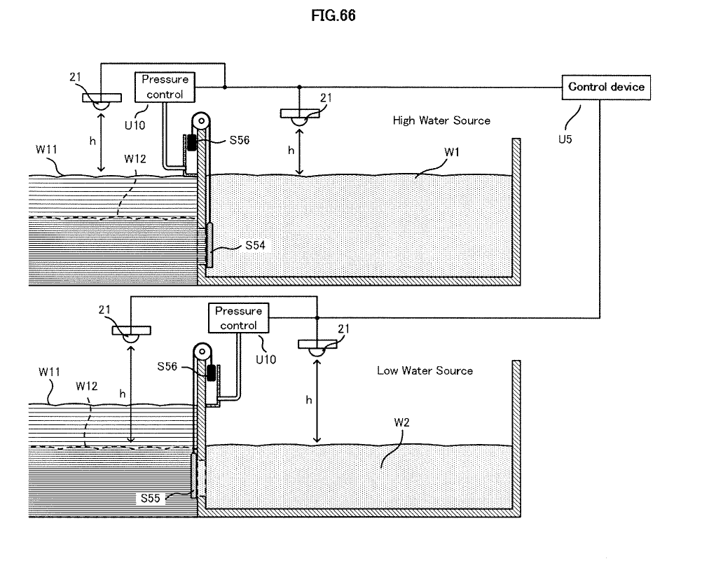

As for the Manufacturing Method of the Water Source shown in FIG. 66, the time and the amount of change of tide level change are forecast by calculation. A High Water Source (W1) and a Low Water Source (W2) are obtainable by opening and closing of the Water Source Valve (S54, S55) by time. As for a High Water Source (W1), a Water Source Valve (S54) is opened at time for a tide level to rise, a Water Source Valve (S54) is closed in time of the peak of a tide level, a High Water Source (W1) is obtainable with the above. As for a Low Water Source (W2), a Water Source Valve (S55) is opened at time for a tide level to drop, a Water Source Valve (S55) is closed at the bottommost time of a tide level, a Low Water Source (W2) is obtainable with the above. As a Water Source Manufacturing Process different from the above, the water level is measured by the Water Level Sensor of a tide level, if a tide level rises from a High Water Source (W1), a Water Source Valve (S54) will be opened, a Water Source Valve (S54) is closed at the time of the peak of a tide level, a High Water Source (W1) is obtainable with the above. If a tide level drops from a Low Water Source (W2), a Water Source Valve (S55) will be opened, a Water Source Valve (S55) is closed at the time of bottommost of a tide level, a Water Source is obtainable with the above. Although it is the Water Source Valves (S54, S55) in the drawing, the function is possible also at the sluices.

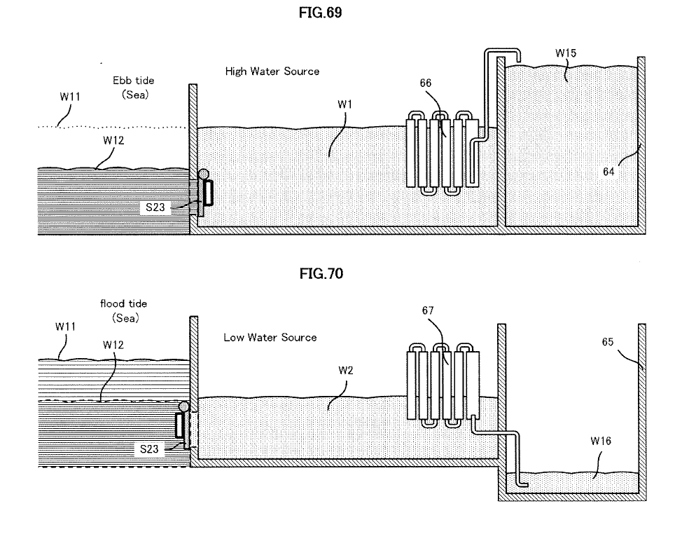

The mechanism of FIGS. 67-70 is explained, if the underwater valve drive energy is removed, it has the function of the non-power pump. FIG. 67 is explained, Series connection of the Open Air Ducts of two-set the Pair 3rd Tanks is made, as for the end of this series connection, it becomes structure which connected that Open Air Duct and the open air duct of the Outflow Tank (T25). The Non-return Valve (S57) of the outflow directions is set from underwater of an Outflow Tank (T25), it is the Outflow Pipe (D67), Water is sent to the Summation High-water Level Tank (64) of the high position by it rather than the High Water Source (W1). As for that operating procedure, all the Underwater Passage Valves (S3) are closed, although omitted on the figure, all the Pressure Open Valves are opened. (Airtight Opening) Feed-Water Valve-Control of the 3rd Tank A (T21) is performed and made it full of water. Drain Valve-Control of the 3rd Tank B (T22) is performed and made it bottom of water. Feed-Water Valve-Control of the 3rd Tank C (T23) is performed and made it full of water. Drain Valve-Control of the 3rd Tank D (T24) is performed and made it bottom of water. Feed-Water Valve-Control of the Outflow Tank (T25) is performed and made it full of water. As for after-completion of aforesaid feed-and-drain, all the Feed-and-Drain Valves are closed, all the Pressure Open Valves are closed (Cessation of Airtight Opening). This condition is the completion of preparation of the Outflow Pump. Control of occurrence of the pressure of a series of Tanks is possible for the following parts, if all of the Input-and-output Air Valve (V67), the between Tanks Air Duct Valve (V68, V69), and the Underwater Passage Valve (S3) are opened, water is pushed out to the Summation High-water Level Tank (64) by the pressure summed from the Outflow Pipe (D67). This operating procedure is the Outflow Pump Process. Aforesaid pump system of the outflow is the Outflow Pump. Although the serial interlock of FIG. 67 of the Pair 3rd Tanks are two sets, this interlock can be increased. As for the operating procedure of the Feed-and-Drain Valve which increased connection, the increased Pair 3rd Tanks becomes the process which repetition of that item increases. “h” is a mutual water level difference of the Pair 3rd Tank. As for the push-pressure first stage the mechanism of FIG. 67, the water level of each the Pair 3rd Tank is equal. The push-pressure of “1 h” is summed by one Pair 3rd Tank, as for a figure, it is pushed out by the pressure of “2 h” from the water surface of the High Water Source,

FIG. 68 is explained, series connection of the Open Air Duct of two-set of the Pair 3rd Tanks is made, as for this series connection, this Open Air Duct of one end and an Open Air Duct of the 1st Tank (T1) are connected, as for another end of this series connection, it becomes structure which connected that Open Air Duct and an Open Air Duct of the Inflow Tank (T26). As for the Inflow Pipe (D68) in which the Non-return Valve (S58) of the inflow directions was set from the underwater Inflow Tank (T26), The water of the Summation Low-water Level Tank (65) lower than the Low Water Source (W2) is taken in. As for that operating procedure, all the Underwater Passage Valves (S3) are closed and all the Pressure Open Valves are opened. (Airtight Opening: The Pressure Open Valve is omitted all over the figure.) Feed-Water Valve-Control of the 1st Tank (T1) is made, and it is made full of water. Drain Valve-Control of the 3rd Tank A (T21) is made, and it is made bottom of water. Feed-Water Valve-Control of the 3rd Tank B (T22) is made, and it is made full of water. Drain Valve-Control of the 3rd Tank is made, and it is made the bottom of water. Feed-Water Valve-Control of the 3rd Tank is made, and it is made full of water. Drain Valve-Control of the Inflow Tank (T26) is made, and it is made the bottom of water. As for after completion of aforesaid feed-and-drain, all the Feed-and-Drain Valves are closed and all the Pressure Open Valves are closed. (Cessation of Airtight Opening) This condition is the completion of preparation of an Inflow Pump. Control of occurrence of the pressure of a series of Tanks is possible for the following parts, if all of the Drain Valve (S2) of the 1st Tank (T1), the Between Tanks air Duct Valve (V68, V69), and the Underwater Passage Valve (S3) opened, water is drawn from the Summation Low-water Level Tank (65) by the pull-pressure summed from the Inflow Pipe (D68). The operating procedure excluding aforesaid Operation of the 1st Tank (T1) is the Inflow Pump Process. The pump system of inflow excluding the 1st Tank (T1) of FIG. 68 is the Inflow Pump. Although the Pair 3rd Tank of the interlock of FIG. 68 is two sets, this interlock can be increased. As for the operating procedure of the Feed-and-Drain Valve which increased the interlock, the repetition of that item increases by the increased Pair 3rd Tanks. In FIG. 68, as compared with FIG. 67, the 1st Tank (T1) is set in the first rank. As for the pull-pressure first stage the mechanism of FIG. 68, the water level difference of the 1st Tank (T1) is “1 h”, the 3rd Tank sums the pressure of “1 h” in one pair, it is pulled up by the pressure of 3 h.

FIG. 67 and FIG. 68 are explained, as for the Outflow Pump Process and the Inflow Pump Process of aforesaid High-pressure Generation Mechanism, this is an operating procedure except the Outflow Tank (T25) and the Inflow Tank (T26), the Outflow Pump Process is applicable to the summed push-pressure occurrence method, the Inflow Pump Process is applicable to the summed pull-pressure occurrence method. In the case of output of the both edges of the series connection of only the Pair 3rd Tanks, it is the push-pressure to which one was summed and is the pull-pressure to which another side was summed. The operating procedure of this High-pressure Generation Mechanism is the High-pressure Occurrence Process.

Although the use of the aforesaid Outflow Pump and Inflow Pump is water, it is possible to handle a lot of liquids.

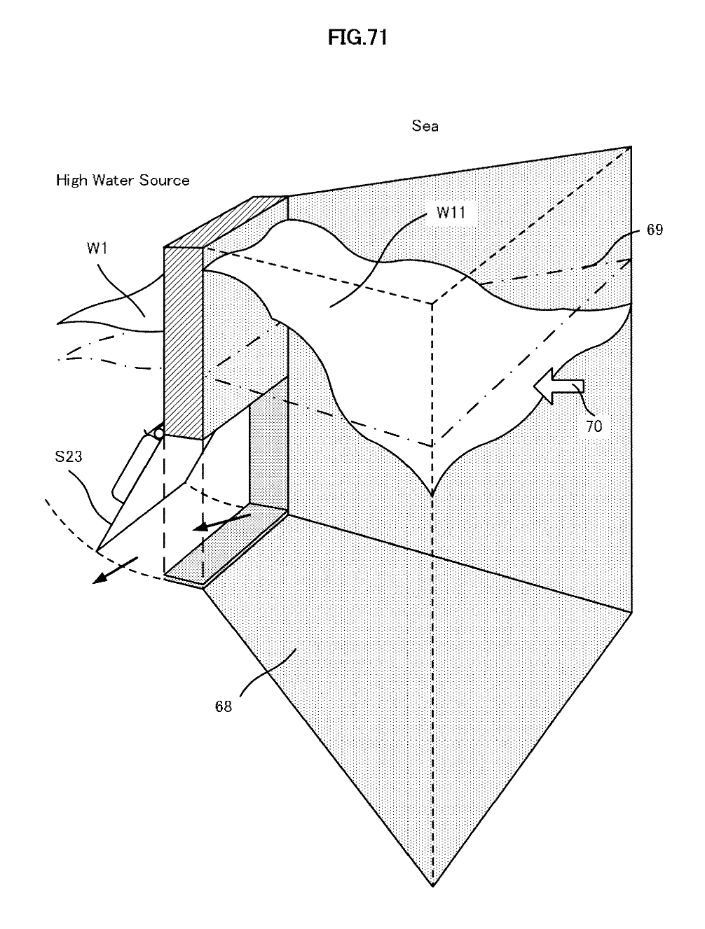

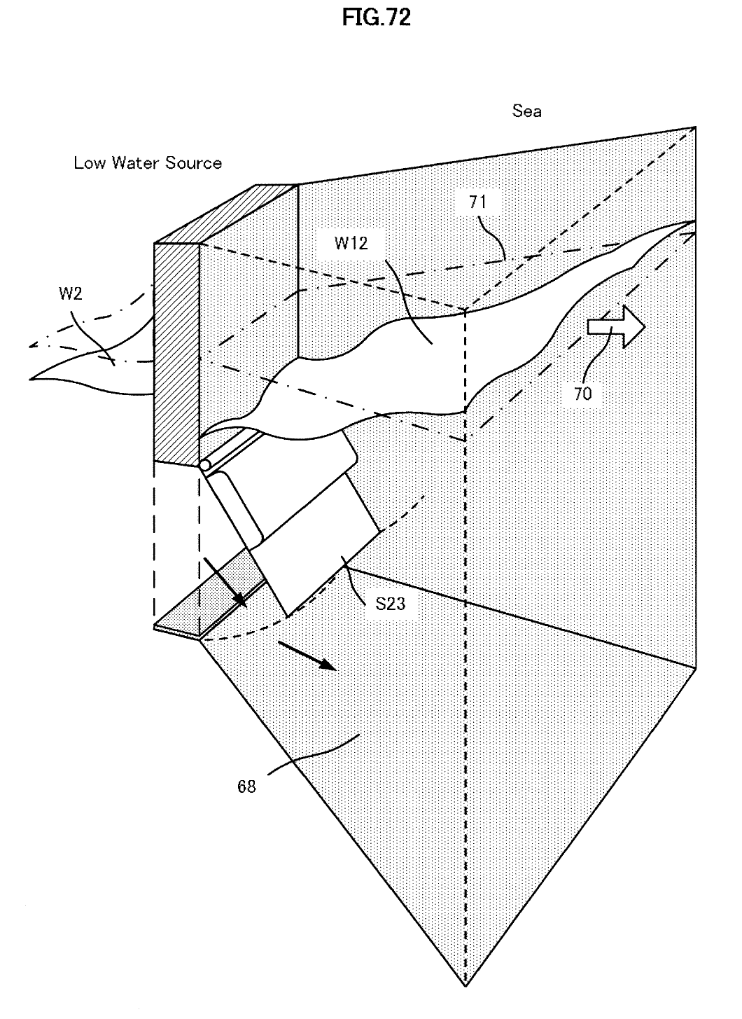

FIG. 71 and FIG. 72 are explained, as for the Water Source acquisition by the tide level difference, it is the mechanism which makes the Water Source the larger water level difference using the waves. As for undulation of the wave, movement of water will become larger water level change, if the movement place becomes narrow suddenly. FIG. 68 is explained, as for, the Flow Path cross section of the Specific-gravity Valve (S23) for inflow makes it the shape which becomes large to the directions of the sea, as for the wave-edge, the water level is flowed in when the water level becomes higher, and the valve is closed when the water level becomes low. The higher High Water Source (W1) is obtained by this mechanism, the aforesaid flow of the Low Water Source (W2) is reverse. FIG. 72 is explained, the Specific-gravity Valve (S23) for the outflow becomes the form to which the flow path section becomes large in the direction of the sea, as for the wave edge, the water level is flowed out when the water level becomes lower, and the valve is closed when the water level becomes high. The lower Low Water Source (W2) is obtained by this mechanism. This mechanism is the Difference Amplification Mechanism of the Water Sources.

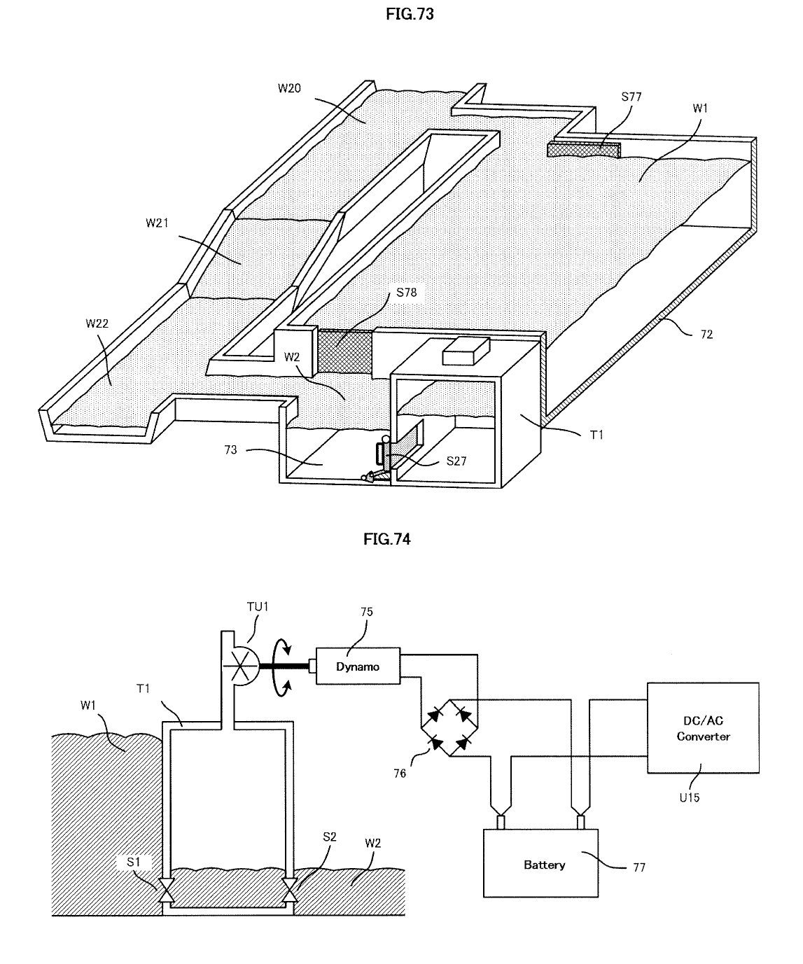

There are many situations in natural geographical feature of making the water source of a low water level difference, as for the Water Source of the low water level difference of a river, if a Slope (W21) is in a river as shown in FIG. 73, the Water Source of a water level difference will be made easily. A stream is taken in from the river upper stream (W20), and amount of water is secured to a River High-water Level Cistern (72), the river lower stream is made into a low level water source (W22), this invention is easily realizable with the above. Drainage of this Pressure Occurrence Mechanism is discharged underwater, although there is no water in a river, the Pressure Occurrence Mechanism must move, then, a Drainage Hollow (73) is established in the drainage side of a tank. The bottom of this Drainage Hollow (73) is a position lower than the bottom of the river lower stream, and it is a hollow which always has water. For this reason, the Locking Specific-gravity Valve (S27) performs performance.

FIG. 74 is explained, although it is the conventional technique, this electric-energy-conversion method is used for wind power generation etc. As for the electric energy acquisition method of an irregular energy generation, the electric power generated with the Dynamo (75) is changed into a direct current by the Rectifier (76), next, a battery (77) charges, the charged electric power is transformed into AC power supply by the DC/AC Converter (U15). As the acquisition method of energy, although the above is the conventional technique, it improves the application of this invention.

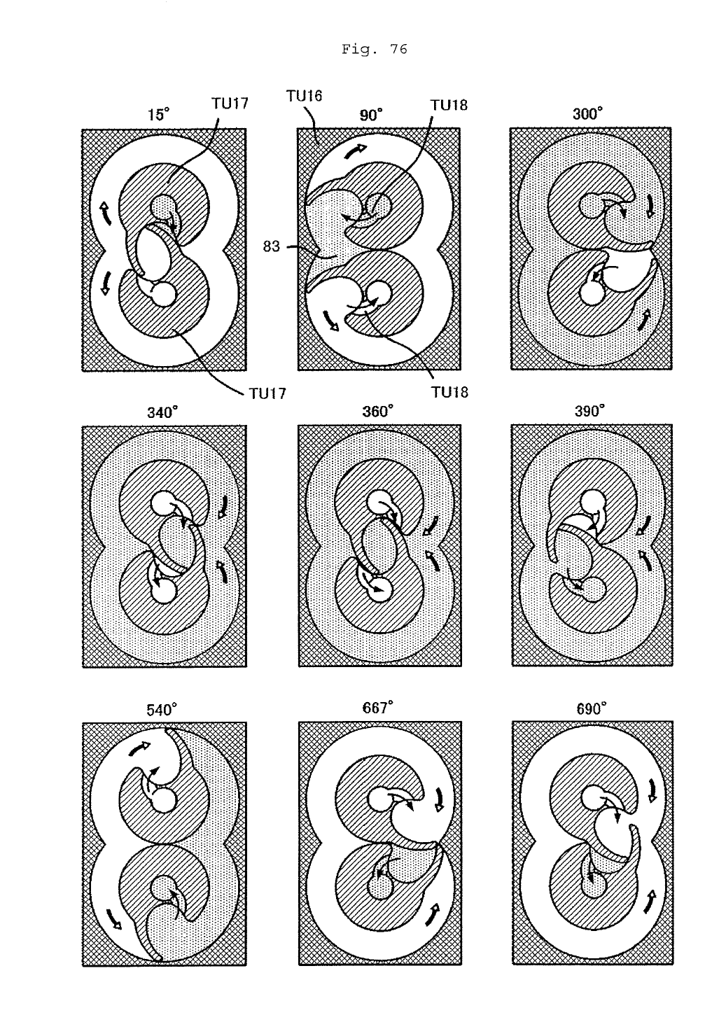

Although the equipment which rotates by the conventional pressure is a Turbine (TU1) of FIG. 75. About a principle of movement, the Rotation Feather (TU15) of a state of stillness has not started by pressure. As for it, pressure (Pt) is uniformly put on the Rotation Feather (TU15). However, once it rotates, the direction of a flow will become torque, and a turbine functions. The rotative direction of a turbine is reversed in this invention, hence, the equipment which rotates by pressure from the state of stillness of a turbine is needed.

FIG. 76 is explained. This air turbine was devised for this invention, torque is obtained by volume change of Sealing Space (83), pressure turns into torque from the state of stillness of a turbine. Two Rotation-solids (TU17) have meshed with the gears, the axis of rotation has passage (TU18). sealing Space (83) continues volume change by rotation, pressure is convertible for torque at 360 degrees. Hence, it is equipment needed for this invention that pressure reverses. Japan Application for patent 2006-84161. U.S. application for patent Ser. No. 12/230, 884. Thereby, the efficiency of this invention is improved.

1. A little water level difference large flow power generator, comprising: there is a Tank placed between a Low Water Source and a High Water Source, there is a Feed Water Valve for opened and closed between that Tank and its High Water Source, there is a Drain Valve for opened and closed between that Tank and its Low Water Source, its Tank is equipped with an Open Air Duct of the input-and-output of pressure, this passes Tank space to the exterior, this is Push-pressure occurs in its Open Air Duct by Feed-Water Valve-Control, this is Pull-pressure occurs in its Open Air Duct by Drain Valve-Control, above is the characteristic of this Pressure Occurrence Mechanism, the above is the 1st comprise of the 1st Tank, as for the 2nd comprising, there are the two aforesaid 1st Tanks, the both Tank Space of 1st Tank has passed by the Between Tanks Air Duct, this Between Tanks Air Duct can equip a turbine, the above is a Pair 2nd Tank, as for this Pair 2nd Tank, it is possible to make that turbine drive by the Feed-Water Valve-Control of one 2nd Tank and the Drain Valve-Control of another 2nd Tank, as for 3rd comprising, there are the two aforesaid 1st Tanks, the both underwater of 1st Tank has passed by the Underwater Passage, this Underwater Passage is equipped with an Underwater Passage Valve, the above is a Pair 3rd Tank, all the Feed-and-Drain Valves of its Pair 3rd Tank are closed, as for the situation of one bottom-of-water 3rd Tank and another Full-of-water 3rd Tank, if that Underwater Passage Valve opening is made, the Open Air Duct of the former 3rd Tank become push-pressure, the Open Air Duct of the latter 3rd Tank become pull-pressure, as for an aforesaid the 1st Tank-the 3rd Tank, the Electrical Control Unit which controls opening and closing of an aforesaid an Underwater Valve is equipped, that Electrical Control Unit makes pressure by opening and closing of that Underwater Valve, the above is the Pressure Occurrence Mechanism.

2. The little water level difference large flow power generator according to claim 1, these Locking Valves of the 1st Tank-the 3rd Tank equips the Specific-gravity Valves, it is the characteristic which can be opened and closed with little energy, this is the Locking Specific-gravity Valve Mechanism.

3. The little water level difference large flow power generator according to claim 1, the Underwater Valves of the 1st Tank-the 3rd Tank equips the Specific-gravity Valve, as for the 1st Specific-gravity Valve, that Underwater Valve is driven from upside water, that movable Structure is equipped with the weight of balance structure of a pulley or seesaw, the underwater weight of that Underwater Valve and that upside water weight are balanced nearly, hence, the underwater Specific-gravity of the Underwater Valve resembles the Specific-gravity of water, as for the 2nd Specific-gravity valve, this Underwater Valve equips emptiness structure made to resemble to the Specific-gravity of water, as for the structure of the aforesaid 1st Specific-gravity Valve and the aforesaid 2nd Specific-gravity Valve, this reduces the drive bottleneck of opening and closing by own weight, and it is movable with few streams, above is the Specific-gravity Valve Mechanism.

4. The little water level difference large flow power generator according to claim 2, as for the mechanism of the Specific-gravity Valve of the 1st Tank-the 3rd Tank, the Underwater Valve is driven from upside water, the power equipment which makes it drive is equipped, this opens and closes that Specific-gravity Valve with little energy, the above is a Specific-gravity Valve Drive.

5. The little water level difference large flow power generator according to claim 1, as for the simplex tank of above 1st Tank-3rd Tank, the Forced Closing Valve which overlapped with both or one side of the aforesaid Feed-and-Drain Valves are equipped, if Accident Flow occurs, that Forced Closing Valve is closed by electronic control, the above is the feature of this Pressure Occurrence Mechanism.

6. The little water level difference large flow power generator according to claim 1, as for the structure which obstructs opening of a Locking Valve of the 1st Tank-the 3rd Tank, the open locus of its Locking Valve is equipped with the Locking Protrusion of the locking structure of the crank, that Locking Valve obstructs and locks opening in the line of the Crank of the Locking Protrusion, that Locking Valve is opened with the form which breaks down the Crank of the Locking Protrusion which can be Locking-release, it is the Crank Locking Mechanism of the characteristic which locks and Locking-release the Locking Valve as mentioned above.

7. The little water level difference large flow power generator according to claim 1 of the Locking Valve, the equipment which the Locking Protrusion locks on Upside Water is equipped, the electronic device which controls locking by Upside Water is equipped, the above is valve locking mechanism.

8. The little water level difference large flow power generator according to claim 1 of the Underwater Passage, as for the 1st exhaust equipment of the Underwater Passage of the Pair 3rd Tank, as for the Underwater Passage between the water surface of a High Water Source, and the water surface of a Low Water Source, an Underwater Passage Exhaust Passage with a Underwater Passage Exhaust Valve is equipped, about Feed-Water Valve-Control of the 3rd Tank which the Underwater Passage Exhaust Passage has passed, the air of the Underwater Passage is exhausted by opening of the Underwater Passage Exhaust Valve, as for the 2nd exhaust equipment, about the Underwater Passage above the water surface of the Low Water Source, the Underwater Passage Exhaust Passage with the Underwater Passage Exhaust Pump is equipped, the air of Underwater Passage is exhausted with the Underwater Passage Exhaust Pump, as for the 1st exhaust equipment and 2nd exhaust equipment, this is the exhaust equipment which exhausts the air of the Underwater Passage.

9. The little water level difference large flow power generator according to the 1st Tank-the 3rd Tank, the 1st Tank-the 3rd Tank are equipped with the water level sensor which measures the water level to the High Water Source, the Low Water Source, and the 1st Tank-the 3rd Tank, based on the data of each water level sensor, each Underwater Valve is opened and closed with the Electrical Control Unit, the above is the Pressure Occurrence Mechanism of the characteristic.

10. The little water level difference large flow power generator according to 1st Tank-3rd Tank, as for the 1st Pressure Occurrence Mechanism of the 1st Tank-the 3rd Tank, the 1st Tank and the 3rd Tank are equipped with the parallel Open Air Ducts with the turbine, as for the 2nd Pressure Occurrence Mechanism, the Pair 2nd Tank is equipped with the parallel Between Tanks Air Ducts with the turbine, as for the above 1st Pressure Occurrence Mechanism and the above 2nd Pressure Occurrence Mechanism, energy is synthetically obtained from those by the Selection Drive of each turbine, thus, the Selection Drive of each turbine is made from the Displacement Optimization Program of electronic control, the Selection Driving of Pressure Occurrence Mechanism characterized by the above.

11. The little water level difference large flow power generator according to claim 10, as for the 1st Torque Aggregate Mechanism of Pressure Occurrence Mechanism of Selection Drive, extension of each turbine at the Pressure Occurrence Mechanism of Selection Drive is equipped with the clutch, the Passage Ducts of those turbines are equipped with the Duct Valves, aggregate Torque of those clutches is Output, the Selection Drive is available by interlocking with opening of the Duct Valves and Rotation Connection of the clutches, the Selection Drive is null by interlocking with closing of the Duct Valves and release of the clutches, as for the 2nd Torque Aggregate Mechanism, Rotation Connection of the rotation axes of all the turbines of the Pressure Occurrence Mechanism of the Selection Drive is made, all those turbines are equipped with the Feedback Air Duct, its Passage Ducts of those turbines are equipped with Duct Valves, all the Feedback Air Ducts are equipped with the feedback valves, as for opening of the Duct Valve and closing of the Feedback Valve, the Selection Drive is available because torque occurs to the turbines, as for closing of the Duct Valve and opening of the Feedback Valve, the Selection Drive is null because the turbines idles, as for the 3rd Torque Aggregate Mechanism, Rotation Connection of the rotation axes of all the turbines of the Pressure Occurrence Mechanism of the Selection Drive is made, all those turbines are equipped with the Feedback Air Ducts, the Change Valves of passage of the Passage Ducts and passage of the Feedback Air Duct are equipped, as for passage of the Passage Duct and closing of the Feedback Air Duct, the torque of the turbine occurs and the Selection Drive is available, as for closing of the Passage Duct, and passage of the Feedback Air Duct, the turbine idles and Selection Drive is null, as for the 4th Energy Aggregate Mechanism, the rotation axes of all the turbines of the Pressure Occurrence Mechanism of the Selection Drive are equipped with the dynamos, moreover, the Accumulation-of-electricity Mechanism of those dynamos is equipped, the Selection Drive with electric charging of the dynamo is available, the Selection Drive with cannot electric charging of the dynamo is null, as for the 1st Torque Aggregate Mechanism-the 3rd Torque Aggregate Mechanism and the 4th Energy Aggregate Mechanism, the energy which gathered is obtained from Displacement Optimization Program of electronic control, the above is the Energy Aggregate Mechanism of the characteristic.

12. The little water level difference large flow power generator according to claim 1, as for plural Pair 3rd Tanks, Series connection of the Open Air Duct of those both edges is made, as for that series connection of the Open Air Duct of one edge and the Open Air Duct of another edge, one of it or both are set as an input/output, as for the electronic control by High-pressure Occurrence Process, the Underwater Valve of each 3rd Tank is opened and closed, summation push-pressure occurs to the Open Air Duct of one edge of series connection, summation pull-pressure occurs in another Open Air Duct, the above is the High-pressure Generation Mechanism.

13. The little water level difference large flow power generator according to claim 12, the Open Air Duct of one end of this High-pressure Generation Mechanism and the Open Air Duct of the 1st Tank are connected, as for the composition of an Outflow Pump, an Outflow Pipe is equipped with the Non-return Valve which flows in the extrusion direction, this Outflow Pipe is passed by the Summation High-water Level Tank higher than the water level of the High Water Source from underwater of that 1st Tank, that 1st Tank is an Outflow Tank, as for the composition of an Inflow Pump, an Inflow Pipe is equipped with the Non-return Valve which flows in the raising direction, that Inflow Pipe is passed by the Summation Low-water Level Tank lower than the water level of the Low Water Source from underwater of that 1st Tank, that 1st Tank is an Inflow Tank, as for the electronic control of the aforesaid Outflow Pump, each Underwater Valve is opened and closed with the Outflow Pump Process, as for the electronic control of the aforesaid Inflow Pump, each Underwater Valve is opened and closed with the Inflow Pump Process, it is a pump mechanism of the aforesaid characteristic.

14. The little water level difference large flow power generator according to claim 3, as for the case which the Specific-gravity Valves are used for the Water Source Valve, the Water Source Valve which flows to the inflow directions is equipped between the tide level and the High Water Source, the Water Source Valve which flows to the outflow directions is equipped between the tide level and the Low Water Source, that High Water Source and its Low Water Source are made into the Water Source of the Pressure Occurrence Mechanism, the above is the Water Source Making Mechanism of the characteristic.

15. The little water level difference large flow power generator according to claim 14, as for the Water Source Valve of the Water Source Making Mechanism, that Flow Path cross section makes it the structure which spreads to the directions of the sea, the vertical interval of the wave brought near by the Water Source Valve by the variation of the wave is emphasized, this increases the flow to the Water Source Valve, and the vertical interval of the Water Source is increased, the above is the Water Source Vertical Interval Increase Mechanism of the characteristic.

16. The little water level difference large flow power generator according to claim 1, as for the case of river installation, the High Water Source of the Pressure Occurrence Mechanism is a River High-water Level Cistern, a sluice is equipped between the upper stream of a river and the River High-water Level Cistern, the lower stream of a river is equipped with the Low Water Source where the Drain Hollow was attached, the water of a high-water level is taken in from the river upper stream by the sluice, this is a water source of the Pressure Occurrence Mechanism.

17. The little water level difference large flow power generator according to claim 5, as for the control method of the aforesaid Forced Closing Valve, the 1st Tank-the 3rd Tank are equipped with the Forced Closing Valve, a water level sensor and a stream sensor are equipped in the 1st Tank-the 3rd Tank, if a stream without water level change in the 1st Tank-the 3rd Tank occurs, a judgment is made in case of the Accident Flow, because the Forced Closing Valve is closed by electronic control, that Accident Flow is stopped, this is the control method of the Forced Closing Valve.

18. The little water level difference large flow power generator according to claim 5, as for the control method of a Forced Closing Valve, all the Underwater Valves of the 1st Tank-the 3rd Tank are equipped with a Valve Sensor, as for the tank of the simplex of either the 1st Tank-the 3rd Tank, the condition that both a Feed Water Valve and a Drain Valve are open is the 1st Detection, this is the 1st Detection Forced Closing Valve, as the 2nd Detection of the Pair 3rd Tank, opening of an Underwater Passage Valve, opening of the Feed Water Valve of one 3rd Tank, and opening of the Drain Valve of another 3rd Tank, the 2nd Detection is these three, a Forced Closing Valve is double equipped to one of Feed Water Valve and Drain Valve, this is the 2nd Detection Forced Closing Valve, as for the case where the 1st Detection or the 2nd Detection occurs by the Valve Sensor, the former is closed by electronic control in the 1st Detection Forced Closing Valve, the latter is closed by electronic control in the 2nd Detection Forced Closing Valve, this is the Forced Closing Valve Control Method of stopping the Accident Flow.

19. The little water level difference large flow power generator according to claim 8, as for the Discharge Method of the air of the Underwater Passage of the 1st Exhaust Equipment, about the Underwater Passage Exhaust Passage of the 1st Exhaust Equipment, the Feed-Water Valve-Control of the 3rd Tank passed to it is performed, this Underwater Passage Exhaust Valve is opened, the air of this Underwater Passage is exhausted, an Underwater Passage Exhaust Valve is closed after that close, this is the Underwater Passage Air Discharge Method.

20. The little water level difference large flow power generator according to claim 1, as for the drive method of the 1st Tank-the 3rd Tank, these 1st tank-the 3rd tank are equipped with the Pressure Open Valve, about the tank water level of the 1st tanks and the 2nd Tank, the water level difference to the Water Source water level of the side which a valve opens is the 1st Water Level Difference, as for opening of the Underwater Passage Valve of the Pair 3rd Tank, the water level difference of this mutual 3rd Tank is the 2nd Water Level Difference, as for closing of the Underwater Passage Valve of the Pair 3rd Tank, about the tank water level of one of the 3rd Tank, the water level difference to the Water Source water level of the side which a valve opens is the 3rd Water Level Difference, as for the case where the 1st Water Level Difference-the 3rd Water Level Difference are the Unnecessary Procurement Water Level Difference, the Pressure Open Valve is opened by electronic control, because to perform feed-and-drain of a tank quickly, the above is the Pressure Occurrence Method of the characteristic.

21. The little water level difference large flow power generator according to claim 1, as for the Drive Method of the 1st Tank-the 3rd Tank, this tank of the Passage Duct is equipped with Pressure Load, noting that it is based on the time of an open start of an Underwater Valve, the electronic control of the Feed-and-Drain Time Program opens and closes the Underwater Valves and the Air Valves, the above is the characteristic of this Pressure Occurrence Method.

22. The little water level difference large flow power generator according to the Drive Method of the 1st Tank-the 3rd Tank, as for the plural 1st Tanks or plural Pairs 2nd Tank, or the plural Pairs 3rd Tank, these Passage Ducts are equipped with the turbines, the energy of the torque of these plural turbines is collected, the cycle of opening and closing of the Underwater Valve of these Tanks are shifted by parallel action of the Phase Difference Smooth Program of electronic control, it is decreasing fluctuation of recoverable energy, the above is the characteristic of the energy recovery method.

23. The little water level difference large flow power generator according to claim 11, as for Selection Drive Pressure Occurrence Mechanism, the 1st Tank-the 3rd Tank are equipped with plural parallel Passage Duct with a turbine, the Selection Drive of each turbine is made in the electronic control of Displacement Optimization Program, hence, the variation of the acquirement energy is decreased by switchover of the total capacity of a turbine, the above is the Energy Acquirement Method of the characteristic.

24. The little water level difference large flow power generator according to claim 12, as for the drive method of the High-pressure Generation Mechanism, moreover, as for the polarity of the unit of the Pair 3rd Tanks of the order of this series connection, it is stipulated that one is the 3rd Tank A and another side is the 3rd Tank B, all the the Underwater Passage Valve of the High-pressure Generation Mechanism is closed, the Airtight Opening of all the Tanks is made, the Feed-Water Valve-Control of all the 3rd Tanks A is made, the Drain Valve-Control of all the 3rd Tanks B is made, as for the above, closing of all the Feed-and-Drain Valves and the cessation of the Airtight Opening are the completion of preparation of the High-pressure Occurrence, the Air pass of all the Passage Duct of series connection is made, and all the Underwater Passage Valves are opened, the Summed Pull-pressure occurs in the Open Air Duct of the 3rd Tank A to the edge of series connection, the Summed Push-pressure occurs in Air Duct of the 3rd Tank B of an another side edge, the above is the High-pressure Occurrence Method by the High-pressure Occurrence Process.

25. The little water level difference large flow power generator according to the Drive Method of the aforesaid Outflow Pump claim 13, as for the direction to the Series Connection of the Outflow Pump by the Pair 3rd Tanks of simplex, it is postulated that the Outflow Tank side of that is the 3rd Tank B, and it is postulated that the other side of this is the 3rd Tank A, as for a control process, all the Underwater Passage Valves of an Outflow Pump are closed, airtight Opening of all the Tanks are performed, Feed-Water Valve-Control of an Outflow Tank and all the 3rd Tank A are performed, Drain Valve-Control of all the 3rd Tank B is performed, all the Feed-and-Drain Valves are closed, sealing of Airtight Opening of all the Tanks are performed, the above condition is made standby of pump action, if it passes through all the Passage Duct of this series connection, furthermore, If opened by all the Underwater Passage Valves, it sends out water with an Outflow Pipe to a cistern with higher than the High Water Source, this is the Outflow Pump Control Method by an Outflow Pump Process.

26. The little water level difference large flow power generator according to the Drive Method of the aforesaid Inflow Pump claim 13, as for the direction to the Series Connection of the Inflow Pump by the Pair 3rd Tanks of simplex, it is postulated that the Inflow Tank side of that is the 3rd Tank B, and it is postulated that the other side of this is the 3rd Tank A, as for a control process, all the Underwater Passage Valves of an Inflow Pump are closed, Airtight Opening of all the Tanks are performed, Drain Valve-Control of an Inflow Tank and all the 3rd Tank A are performed, Feed-Water Valve-Control of all the 3rd Tank B is performed, all the Feed-and-Drain Valves are closed, sealing of Airtight Opening of all the Tanks are performed, the above condition is made standby of pump action, if it passes through all the Passage Duct of this series connection, furthermore, if opened by all the Underwater Passage Valves, it take in water with an Inflow Pipe to a cistern with lower than the Low Water Source, this is the Inflow Pump Control Method by an Inflow Pump Process.

27. The little water level difference large flow power generator according to claim 1, as for the Production Mechanism of the Water Source of the Pressure Occurrence Mechanism, the Tide Level Detection Sensors and the Electronic Opening-and-closing Floodgates between the tide level and the Water Sources are equipped, as for the information on the Tide Level Detection Sensor, its floodgate of the High Water Source is opened at the time of the high-water level, its floodgate of the High Water Source is closed except the time of the high-water level, its floodgate of the Low Water Source is opened at the time of the low water level, its floodgate of the Low Water Source is closed except the time of the low water level, it is the Water Source Manufacturing Method which makes the Water Sources from the tide level by opening and closing of both the floodgates by the above electronic control.

28. The little water level difference large flow power generator according to claim 1, as for the Water Source Production Method of the Pressure Occurrence Mechanism, the sluice opened and closed by an Electrical Control Unit is equipped between a tide level and a Water Source, as for the electronic control by time, the sluice of a High Water Source opens on the assumed high tide schedule, the sluice of the High Water Source closes except a high tide schedule, the sluice of a Low Water Source opens to the assumed ebb tide schedule, the sluice of a Low Water Source closes except an ebb tide schedule, it is a Water Source Manufacturing Process which makes a Water Source from a tide level by opening and closing by the aforesaid Electrical Control Unit.

29. The little water level difference large flow power generator according to claim 3, as for the mechanism of the Specific-gravity Valve of the 1st Tank-the 3rd Tank, the Underwater Valve is driven from upside water, the power equipment which makes it drive is equipped, this opens and closes that Specific-gravity Valve with little energy, the above is a Specific-gravity Valve Drive.
